(19) United States
(12) Patent Application Publication
(10) Pub. No.: US 2025/0280296 A1
(43) Pub. Date: Sep. 4, 2025

(54) Communications Systems with Header and Acknowledgement Integrity Protection

(71) Applicant: Apple Inc., Cupertino, CA (US)

(72) Inventors: Jarkko L. Kneckt, Los Gatos, CA (US); Yong Liu, Campbell, CA (US); Yanjun Sun, San Diego, CA (US); Charles F. Dominguez, San Carlos, CA (US); Leonid Epstein, Netanya (IL); Yoel Boger, Shoham (IL); Yong Ho Seok, Cupertino, CA (US)

(21) Appl. No.: 19/012,627

(22) Filed: Jan. 7, 2025

Related U.S. Application Data
(60) Provisional application No. 63/561,087, filed on Mar. 4, 2024.

(51) Int. Cl. H04W 12/106; H04L 5/00; H04W 8/26

(52) U.S. Cl. CPC H04W 12/106; H04L 5/0055; H04W 8/26

(57) ABSTRACT

A communication system is provided in which access points (APs) communicate with stations (STAs). The APs and STAs may convey integrity-protected frames. The APs and STAs may integrity check the integrity-protected frames. The APs and STAs may transmit integrity-protected block acknowledgement (BA) frames in response to receiving integrity-protected frames. The APs and STAs may integrity check the integrity-protected BA frames. Padding may be inserted into the integrity-protected frames and/or BA frames to accommodate processing delays associated with generating and verifying message integrity checks (MICs) in the frames and/or BA frames. Integrity checking the frames may be performed before, after, or both before and after transmitting a corresponding BA frame.

This application claims the benefit of U.S. Provisional Patent Application No. 63/561,087, filed Mar. 4, 2024, which is hereby incorporated by reference herein in its entirety.

### FIELD

This disclosure relates generally to wireless communications, including wireless communications by electronic devices.

### BACKGROUND

Communications systems and methods are used to convey wireless data between nodes of a communications network. The nodes can include user equipment devices, wireless access points, wireless base stations, or other electronic devices.

It can be challenging to ensure that communications systems exhibit sufficient levels of performance. If care is not taken, wireless data transmitted by a first device might not be properly received at a second device. In addition, the wireless data can be susceptible to security risks such as man-in-the-middle (MITM) attacks while being conveyed between the first and second devices.

### SUMMARY

A communication system is provided in which access points (APs) communicate with stations (STAs). The APs and STAs may convey integrity-protected frames. The APs and STAs may integrity check the integrity-protected frames. The APs and STAs may transmit integrity-protected block acknowledgement (BA) frames in response to receiving integrity-protected frames. The APs and STAs may integrity check the integrity-protected BA frames. Padding may be inserted into the integrity-protected frames and/or BA frames to accommodate processing delays associated with generating and verifying message integrity checks (MICs) in the frames and/or BA frames. Integrity checking the frames may be performed before, after, or both before and after transmitting a corresponding BA frame.

An aspect of the disclosure provides a method of operating a first electronic device to wirelessly communicate with a second electronic device. The method can include transmitting, using one or more antennas, an integrity-protected frame for receipt by the second electronic device. The integrity-protected frame can include a preamble, a media access control (MAC) header, a delimiter between the preamble and the MAC header, a message integrity check (MIC) field based on the MAC header, a data payload, the MAC header being between the data payload and the delimiter, and a padding field configured to accommodate a processing delay associated with generating or verifying the MIC field.

An aspect of the disclosure provides a method of operating a first electronic device to wirelessly communicate with a second electronic device. The method can include receiving, using one or more antennas, a frame. The method can include transmitting, using the one or more antennas, an integrity-protected block acknowledgement (BA) frame for receipt by the second electronic device. The integrity-protected BA frame can include a preamble, a block acknowledgment (ACK) to a media access control protocol data unit (MPDU) in the frame, a message integrity check (MIC) field based on the block ACK, the block ACK being between the MIC field and the preamble in the integrity-protected BA frame, and a padding field configured to accommodate a processing delay associated with generating or verifying the MIC field.

An aspect of the disclosure provides a method of operating a first electronic device to wirelessly communicate with a second electronic device. The method can include receiving, using one or more antennas, a frame. The method can include transmitting, using the one or more antennas, a block acknowledgement (BA) frame for receipt by the second electronic device, wherein the BA frame includes a block acknowledgment (ACK) to a media access control protocol data unit (MPDU) in the frame. The method can include attempting to verify, using one or more processors prior to transmission of the integrity-protected BA frame, integrity of a media access control (MAC) header of the MPDU in the frame.

An aspect of the disclosure provides a method of operating a first electronic device to wirelessly communicate with a second electronic device. The method can include receiving, using one or more antennas, a frame. The method can include transmitting, using the one or more antennas, a block acknowledgement (BA) frame for receipt by the second electronic device, wherein the BA frame includes a block acknowledgment (ACK) to a media access control protocol data unit (MPDU) in the frame. The method can include calculating, using one or more processors after of the integrity-protected BA frame, a message integrity check (MIC) value based on at least some of the MPDU. The method can include transmitting, using the one or more antennas, a block acknowledgment request (BAR) frame when the calculated MIC value does not match a corresponding MIC field included in the frame, wherein the BAR frame identifies the MPDU.

### BRIEF DESCRIPTION OF THE DRAWINGS

FIG. 1 is a diagram of an illustrative wireless communications system in with some embodiments.

FIG. 2 is a schematic diagram of an illustrative wireless station (STA) in accordance with some embodiments.

FIG. 3 is a schematic diagram of an illustrative wireless access point (AP) in accordance with some embodiments.

FIG. 4 is a diagram of an illustrative wireless communications system including a first electronic device that communicates with a second electronic device over a wireless communication link in accordance with some embodiments.

FIG. 5 is a timing diagram of an illustrative integrity-protected frame and a corresponding integrity-protected block acknowledgement (BA) frame that may be conveyed between first and second electronic devices in accordance with some embodiments.

FIG. 6 if a flow chart of illustrative operations involved in integrity protecting and integrity checking wireless data conveyed between first and second electronic devices in accordance with some embodiments.

FIGS. 7A-7D are timing diagrams showing how an illustrative integrity-protected frame may be provided with padding at different locations in accordance with some embodiments.

FIG. 8 is a timing diagram showing how an illustrative integrity-protected physical protocol data unit (PPDU) frame may be provided with padding between different media access control protocol data units (MPDUs) in accordance with some embodiments.

FIGS. 9A and 9B are timing diagrams showing how an illustrative integrity-protected frame may be provided with padding at different locations in accordance with some embodiments.

FIG. 10 is a flow chart of illustrative operations involved in using a receiver to integrity check a received frame after transmitting a corresponding BA frame in accordance with some embodiments.

FIG. 11 is a flow chart of illustrative operations involved in using a receiver to integrity check a received frame both before and after transmitting a corresponding BA frame in accordance with some embodiments.

FIG. 12 is a flow chart of illustrative operations involved in using a receiver to integrity check a received frame prior to transmitting a corresponding BA frame in accordance with some embodiments.

FIG. 13 is a diagram showing an illustrative signaling scheme between a multi-layer multi-device (MLMD) AP and an MLMD STA in accordance with some embodiments.

FIG. 14 is a diagram showing how a header message integrity check (MIC) may be placed at different locations within an illustrative integrity-protected frame in accordance with some embodiments.

FIG. 15 is a diagram showing how an illustrative integrity-protected frame may include a combined MIC field that integrity protects both a header and a data payload of the integrity-protected frame in accordance with some embodiments.

FIG. 16 is a diagram of an illustrative integrity-protected multi-STA BA frame having a configurable AID11 field in accordance with some embodiments.

FIG. 17 shows a table outlining different illustrative AID11 fields that may be included in an integrity-protected multi-STA BA frame in accordance with some embodiments.

FIG. 18 is a diagram of two illustrative integrity-protected frames that include time synchronization function (TSF) information for soliciting a corresponding BA frame in accordance with some embodiments.

FIG. 19 is a diagram showing how data frames and BA frames may be conveyed between an illustrative multi-link device (MLD) transmitter and an illustrative MLD receiver in accordance with some embodiments.

FIG. 20 is a timing diagram showing how illustrative first and second devices may mitigate BA off-synchronization using a silent reorder buffer update at the second device in accordance with some embodiments.

FIG. 21 is a timing diagram showing how illustrative first and second devices may mitigate BA off-synchronization using a transmission buffer update delay at the first device in accordance with some embodiments.

FIG. 22 is a diagram showing how reorder buffer status information may be included in the BA control field of an illustrative integrity-protected multi-STA BA frame in accordance with some embodiments.

FIG. 23 shows a table outlining different illustrative AID11 fields that may be included in an integrity-protected multi-STA BA frame having a BA control field with reorder buffer status information in accordance with some embodiments.

### DETAILED DESCRIPTION

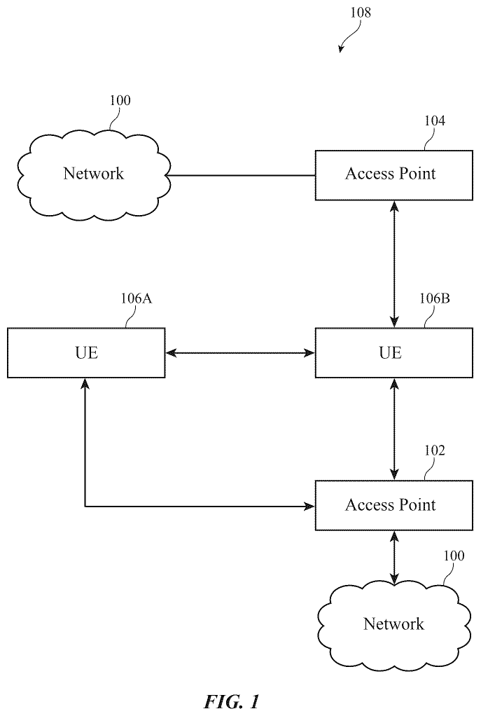

FIG. 1 illustrates an example of a wireless communication system 108 (sometimes also referred to herein as wireless communications network 108, communications network 108, network 108, or system 108). It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown in FIG. 1, the exemplary wireless communication system 108 includes an access point (AP) 104, which communicates over a transmission medium with one or more wireless devices 106 (e.g., a first wireless device 106A, a second wireless device 106B, etc.). Wireless devices 106A and 106B may be user devices (e.g., user equipment (UE) devices), such as stations (STAs), non-AP STAs, or wireless local area network (WLAN) devices. Wireless devices 106 are sometimes referred to herein as STAs 106.

STA 106 may be a device with wireless network connectivity such as a mobile (e.g., cellular) telephone, a hand-held device, a wearable device (e.g., a wristwatch device, pendant device, ring device, head-mounted device such as a virtual, mixed, and/or augmented reality headset, goggles, helmet, or glasses, etc.), a computer (e.g., a desktop computer, laptop computer, a computer monitor containing an embedded computer, etc.), a tablet computer, a media player, headphones, one or two wireless earbuds, a television, a gaming device or console, a navigation device, an embedded system such as a system in which electronic equipment with a display is mounted in a kiosk or automobile, a wireless internet-connected voice-controlled speaker, a home entertainment device, a remote control device, a gaming controller, a user input device, peripheral, or accessory, an electronic stylus or pen, an unmanned aerial vehicle (UAV), an unmanned aerial controller (UAC), an automobile, computing equipment integrated into a vehicle or kiosk, equipment that implements the functionality of two or more of these devices, or virtually any type of wireless device.

STA 106 may include a processor (processing element) that is configured to execute program instructions stored in memory. STA 106 may perform any of the method embodiments described herein by executing such stored instructions. Alternatively, or in addition, STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

Wireless communications system 108 may include one or more wireless access points (APs) such as AP 102. AP 102 may be a stand-alone AP or an enterprise AP and may include hardware that enables wireless communication with STAs 106 such as STA 106A and STA 106B. AP 102 may also be equipped to communicate with a network 100 (e.g., a WLAN, an enterprise network, and/or another communication network connected to the Internet, among various possibilities). Thus, AP 102 may facilitate communication among STA devices 106 and/or between STA devices 106 and network 100. AP 102 can be configured to provide communications over one or more wireless technologies, such as any of 802.11 a, b, g, n, ac, ad, ax, ay, be, bn, and/or other 802.11 versions, or a cellular protocol, such as 5G or LTE, including in an unlicensed band (LAA).

Network 100 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 100 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 100 may include network switches, network routers, optical add-drop multiplexers, other multiplexers, repeaters, modems, portals, gateways, servers, network cards (line cards), wireless access points, wireless base stations, and/or any other desired network components. The network nodes in network 100 may include physical components such as electronic devices, servers, computers, network racks, line cards, user equipment, etc., and/or may include virtual components that are logically defined in software and that are distributed across (over) two or more underlying physical devices (e.g., in a cloud network configuration).

The communication area (or coverage area) of AP 102 (or AP 104) may be referred to as a basic service area (BSA) or cell. AP 102 (or AP 104) and STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc. A given RAT may, for example, specify the physical methodology used in implementing a corresponding communications protocol (e.g., a WLAN protocol, a wireless personal area network (WPAN) protocol, a cellular telephone protocol such as a 3G protocol, a 4G (LTE) protocol, a 5G (NR) protocol, etc., a UWB protocol, a satellite communications protocol, a satellite navigation protocol, a device-to-device (D2D) protocol, etc.).

AP 102, AP 104, and other similar access points (not shown) operating according to one or more wireless communication technologies may thus be provided as a network, which may provide continuous or nearly continuous overlapping service to STAs 106A and 106B and similar devices over a geographic area (e.g., via one or more communication technologies). A STA may roam from one AP to another AP directly or may transition between APs and cellular network cells, for example.

Note that at least in some instances STA 106 may be capable of communicating using any of multiple wireless communication technologies. For example, STA 106 might be configured to communicate using one or more of Wi-Fi, LTE, LTE-A, 5G NR, Bluetooth, UWB, one or more satellite systems, etc. Other combinations of wireless communication technologies (including more than two wireless communication technologies) are also possible. Likewise, in some instances STA 106 can be configured to communicate using only a single wireless communication technology.

As shown in FIG. 1, the exemplary wireless communication system 108 can also include an AP 104, which communicates over a transmission medium with the wireless device 106B. AP 104 also provides communicative connectivity to network 100. Thus, according to some embodiments, wireless devices may be able to connect to either or both of AP 102 (or a cellular base station (BS)) and AP 104 (or another access point) to access the network 100. For example, a STA may roam from AP 102 to AP 104 based on one or more factors, such as coverage, interference, and capabilities. Note that it may also be possible for AP 104 to provide access to a different network (e.g., an enterprise Wi-Fi network, a home Wi-Fi network, etc.) than the network to which the AP 102 provides access.

In some implementations, STAs 106 (e.g., STAs 106A and 106B) may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

STA 106B may also be configured to communicate with STA 106A. For example, STA 106A and STA 106B may be capable of performing direct device-to-device (D2D) communication. In some embodiments, such direct communication between STAs may also or alternatively be referred to as peer-to-peer (P2P) communication. The direct communication may be supported by AP 102 (e.g., AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, Bluetooth (BT), and/or any of various other direct communication techniques, according to various embodiments.

STA 106 may include one or more devices or integrated circuits for facilitating wireless communication, potentially including a WLAN (e.g., Wi-Fi) modem, a cellular modem, and/or one or more other wireless modems. The wireless modem(s) may include one or more processors (processor elements) and various hardware components as described herein. STA 106 may perform any of (or any portion of) the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The wireless modem(s) described herein may be used in a STA as defined herein, a wireless device as defined herein, or a communication device as defined herein. The wireless modem described herein may also be used in an AP, a base station, a pico cell, a femto cell, or other similar network side device.

STA 106 may include one or more antennas for communicating using one or more wireless communication protocols or radio access technologies. In some embodiments, STA 106 can be configured to communicate using a single shared radio. The shared radio may couple to a single antenna, or may couple to multiple antennas (e.g., for multiple-input-and-multiple-output (MIMO)) for performing wireless communications. Alternatively, STA 106 may include two or more radios, each of which may be configured to communicate via a respective wireless link. Other configurations are also possible.

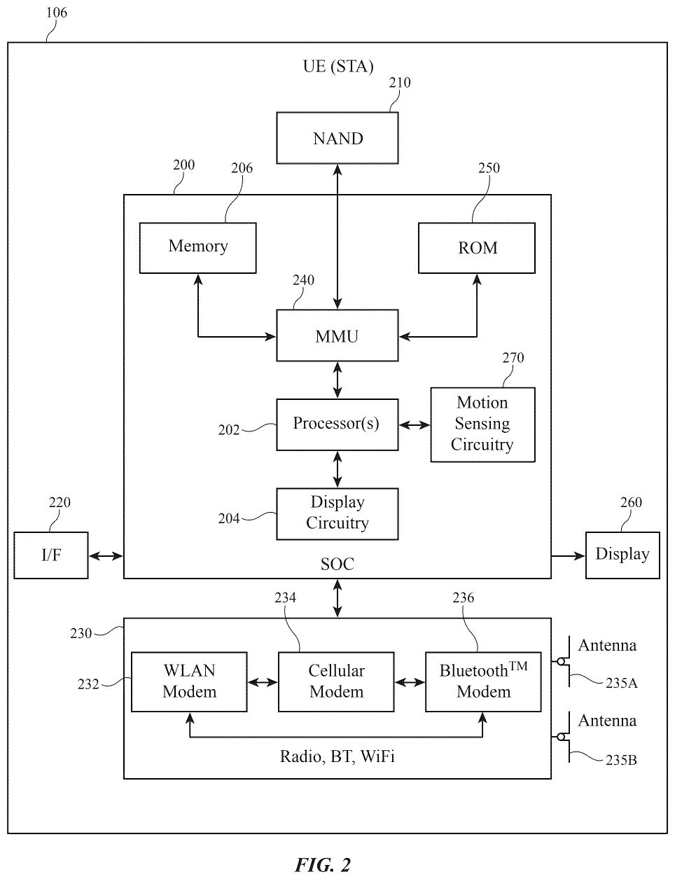

FIG. 2 is one possible block diagram of a STA device such as STA 106. STA 106 is sometimes also referred to herein as UE 106, UE device 106, or device 106. STA 106 also may be referred to herein as non-AP STA 106 or non-AP device 106. As shown in FIG. 2, STA 106 may include wireless circuitry such as wireless communication circuitry 230, a subsystem such as system on chip (SOC) 200, a display such as display 260, and one or more interfaces such as connector interface (I/F) 220.

SOC 200 may include one or more portions configured for various purposes. For example, as shown in FIG. 2, SOC 200 may include one or more processors 202 and display circuitry 204. Processor(s) 202 may execute program instructions for STA 106. Display circuitry 204 may perform graphics processing and may provide display signals to display 260. Display 260 may be a touch-sensitive display, a force sensitive display, or a display without touch or force sensitivity. Display 260 may include one or more arrays of display pixels that emit light containing images, for example.

SOC 200 may also include sensor circuitry such as motion sensing circuitry 270. Motion sensing circuitry 270 may detect motion of the STA 106 using, for example, a gyroscope, accelerometer, inertial measurement unit (IMU), compass, and/or any of various other motion sensing components. Processor(s) 202 may also be coupled to memory management unit (MMU) 240, which may be configured to receive addresses from processor(s) 202 and may translate those addresses to locations in memory or other storage circuitry (e.g., memory 206, read only memory (ROM) 250, flash (NAND) memory 210, etc.). MMU 240 may be configured to perform memory protection and page table translation or set up. In some embodiments, MMU 240 may be included as a portion of processor(s) 202.

SOC 200 may be coupled to various other circuits in STA 106. For example, SOC 200 may be coupled to various types of memory (e.g., flash memory 210), connector interface 220 (e.g., for coupling to a computer system, dock, charging station, etc.), display 260, and wireless communication circuitry 230 (e.g., for performing wireless communications under LTE, LTE-A, 5G NR, Bluetooth, Wi-Fi, NFC, GPS, UWB, etc.).

STA 106 may include at least one antenna 235. If desired, STA 106 may include multiple antennas 235 such as at least a first antenna 235A and a second antenna 235B. STA 106 may use antennas 235 to perform wireless communication with access points, base stations, and/or other devices. For example, STA 106 may use antennas 235A and 235B to perform the wireless communication with APs 102 and/or 104 of FIG. 1. As noted above, STA 106 may, in some embodiments, be configured to communicate wirelessly using multiple wireless communication standards or radio access technologies (RATs).

Wireless communication circuitry 230 may include one or more modems such as WLAN (e.g., Wi-Fi) modem 232, cellular modem 234, and Bluetooth modem 236. If desired, wireless communication circuitry 230 may include additional modems for handling other RATs or wireless communications technologies. STA 106 may use WLAN modem 232 (sometimes also referred to herein as Wi-Fi modem 232) to perform Wi-Fi or other WLAN communications (e.g., on an 802.11 network) with one or more external devices (e.g., AP 104 and/or 102 of FIG. 1). STA 106 may use Bluetooth modem 236 to perform Bluetooth communications or other WPAN communications with one or more external devices (e.g., another STA 106). STA 106 may use cellular modem 234 to perform cellular communications with one or more wireless base stations according to one or more cellular communication technologies (e.g., in accordance with one or more 3GPP specifications).

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods described herein, e.g., by one or more processors executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). STA 106 may include support structures such as a housing. The housing may include conductive and/or dielectric housing walls, layers, and/or other structures.

If desired, STA 106 may include additional include input-output devices (not shown for the sake of clarity). The input-output devices may be used to allow data to be supplied to STA 106 and to allow data to be provided from STA 106 to external devices. The input-output devices may include user interface devices, data port devices (e.g., interface 220), touch sensors, displays (e.g., display 260), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to STA 106 using wired or wireless connections (e.g., some of the input-output devices may be peripherals that are coupled to a main processing unit or other portion of STA 106 via a wired or wireless link).

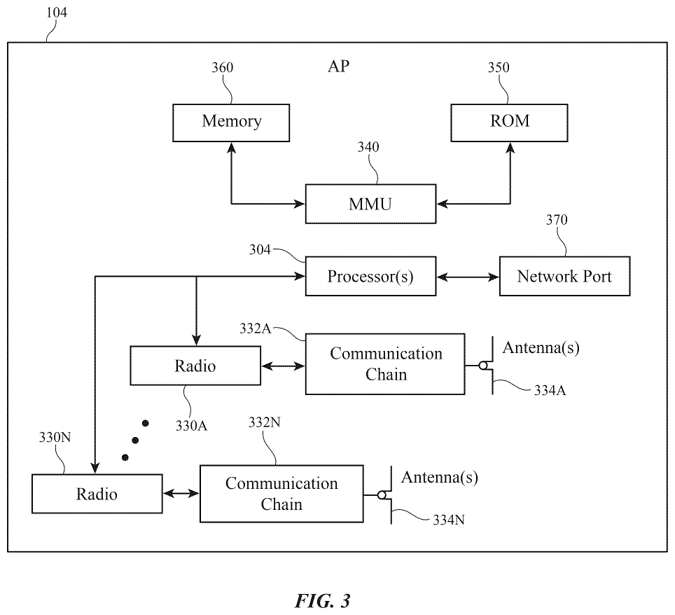

FIG. 3 is an example block diagram of an electronic device such as AP 104 (or equivalently AP 102 of FIG. 1). In some instances (e.g., in an 802.11 communication context), AP 104 may also be referred to as a station (STA), and possibly more particularly as an AP STA. It is noted that the AP of FIG. 3 is merely one example of a possible access point. As shown, AP 104 may include one or more processors 304, which may execute program instructions for AP 104. Processor(s) 304 may also be coupled to MMU 340, which may be configured to receive addresses from processor(s) 304 and to translate those addresses to locations in memory (e.g., memory 360 and ROM 350) or to other storage circuitry, circuits, or devices.

AP 104 may include at least one network port 370. Network port 370 may be configured to couple to a network and to provide multiple devices, such as STAs 106, with access to the network (e.g., network 100 of FIG. 1). Network port 370 (or an additional network port) may also or alternatively be configured to couple to a cellular network (e.g., a core network (CN) of a cellular service provider). The core network may provide mobility related services and/or other services to a plurality of UE devices (e.g., STAs 106). In some cases, network port 370 may couple to a telephone network via the core network, and/or the core network may provide a telephone network (e.g., among other UE devices serviced by the cellular service provider).

AP 104 may include one or more radios 330A-330N, each of which may be coupled to a respective communication chain 332 and at least one antenna 334, and possibly multiple antennas (e.g., a first radio 330A coupled to antenna 334A via communication chain 332A, an Nth radio 330N coupled to antenna 334N via communication chain 332N, etc.). Radios 330 may be configured to operate as wireless transceivers that communicate with STAs 106 via communication chains 332 and antennas 334. Antenna(s) 334A-N communicate with their respective radios 330A-N via communication chains 332A-N. Communication chains 332 may be receive chains, may be transmit chains, or may include both transmit and receive chains. Radios 330A-N may be configured to communicate in accordance with various wireless communication standards including, but not limited to, LTE, LTE-A, 5G NR, 6G, UWB, WLAN (Wi-Fi), WPAN (BT), etc. If desired, AP 104 may be configured to operate on multiple wireless links using the one or more radios 330A-N, where each radio is used to operate on a respective wireless link.

AP 104 may be configured to communicate wirelessly using one or multiple wireless communication standards. In some instances, AP 104 may include multiple radios, which may enable the network entity to communicate according to multiple wireless communication technologies. For example, as one possibility, AP 104 may include an LTE or 5G NR radio for performing communication according to LTE or 5G as well as a Wi-Fi radio for performing communication according to Wi-Fi. In such a case, AP 104 may be capable of operating as both a cellular base station and a Wi-Fi access point. As another possibility, AP 104 may include a multi-mode radio, which is capable of performing communications according to any of multiple wireless communication technologies (e.g., NR and Wi-Fi, NR and LTE, etc.). As still another possibility, AP 104 may be configured to act exclusively as a Wi-Fi access point, e.g., without cellular communication capability.

As described further herein, AP 104 may include hardware and software components for implementing or supporting implementation of features described herein. Processor(s) 304 of AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, processor(s) 304 may be configured as a programmable hardware element, such as an FPGA (Field Programmable Gate Array) or ASIC (Application Specific Integrated Circuit), or a combination thereof. Alternatively (or in addition) the processor(s) 304 of AP 104, in conjunction with one or more of the other components 330, 332, 334, 340, 350, 360, 370 may be configured to implement, or support implementation of, part or all of the features described herein.

Radio(s) 330 on AP 104 may use antenna(s) 334 (FIG. 3) and wireless communication circuitry 230 on STA 106 may use antenna(s) 235 (FIG. 2) to transmit and/or receive radio-frequency signals within different frequency bands at radio frequencies (sometimes referred to herein as communications bands or simply as a “bands”). The frequency bands handled by AP 104 and STA 106 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Antenna(s) 334 (FIG. 3) and antenna(s) 235 (FIG. 2) may be formed using any desired antenna structures. For example, the antennas may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas may include antenna resonating elements formed from conductive portions of a device housing (e.g., peripheral conductive housing structures extending around a periphery of a display on STA 106). Filter circuitry, switching circuitry, impedance matching circuitry, and/or other antenna tuning components may be adjusted to adjust the frequency response and wireless performance of the antennas over time. If desired, multiple antennas may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Wireless communication circuitry 230 may convey radio-frequency signals using antenna(s) 235 (FIG. 2). Radio(s) 330 may convey radio-frequency signals using antenna(s) 334 (FIG. 3). The term “convey radio-frequency signals” as used herein means the transmission and/or reception of the radio-frequency signals (e.g., for performing unidirectional and/or bidirectional wireless communications with external wireless communications equipment). The term “convey wireless data” as used herein means the transmission and/or reception of the wireless data (e.g., as carried by corresponding radio-frequency signals). Antennas may transmit radio-frequency signals by radiating the radio-frequency signals into free space (or to free space through intervening device structures such as a dielectric cover layer). Antennas may additionally or alternatively receive radio-frequency signals from free space (or through intervening devices structures such as a dielectric cover layer). The transmission and reception of radio-frequency signals by antennas each involve the excitation or resonance of antenna currents on an antenna resonating element in the antenna by the radio-frequency signals within the frequency band(s) of operation of the antenna.

Wireless communication circuitry 230 may be coupled to antenna(s) 235 (FIG. 2) over one or more radio-frequency transmission lines. Radio(s) 330 may be coupled to antenna(s) 334 (FIG. 3) over one or more radio-frequency transmission lines. Communication chain(s) 332 (FIG. 3) may be disposed on the radio-frequency transmission lines between antenna(s) 334 and radio(s) 330. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios or modems if desired. Radio-frequency front end (RFFE) modules may be interposed on one or more of the radio-frequency transmission lines if desired (e.g., within communication chain(s) 332 of FIG. 3 or within wireless communication circuitry 230 of FIG. 2). The radio-frequency front end modules may include substrates, integrated circuits, chips, or packages that are separate from the radios or modems and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Processor(s) 202 (FIG. 2) and processor(s) 304 (FIG. 3) may each include one or more processors such as microprocessors, microcontrollers, digital signal processors, host processors, baseband processing circuitry (e.g., one or more baseband processors or baseband processor integrated circuits), application specific integrated circuits (ASICs), FPGAs, central processing units (CPUs), graphics processing units (GPUs), etc. If desired, radio(s) 330 (FIG. 3) and/or wireless communication circuitry 230 may also include one or more processors. Baseband circuitry in STA 106 and/or AP 104 may, for example, access a communication protocol stack on corresponding storage circuitry (e.g., memory 206 of FIG. 2 or memory 360 of FIG. 3) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

AP 104 (or AP 102 of FIG. 1) may communicate with a STA 106 over a corresponding wireless communication link. Radio-frequency signals may be wirelessly conveyed between the radios and antennas on AP 104 and STA 106 to support the wireless communication link. The radio-frequency signals may include wireless data modulated onto one or more carriers of the radio-frequency signal (e.g., by a transmitter in radio 330 of AP 104 or a transmitter in a modem on wireless communication circuitry 230 of STA 106). The wireless data may be organized, modulated onto the radio-frequency signals, and demodulated from the radio-frequency signals (e.g., by a receiver in radio 330 of AP 104 or a receiver in a modem on wireless communication circuitry 230 of STA 106) according to a corresponding communications protocol or standard (e.g., an IEEE 802.11 protocol or standard). The radio-frequency signals may be conveyed in one or more frequency bands associated with the communications protocol.

Implementations in which AP 104 and STA 106 communicate according to an IEEE 802.11 protocol or standard are described herein as an example. Under an 802.11 protocol, the wireless data is organized into a series or flow of frames (e.g., media access control (MAC) frames) carried by the radio-frequency signals. The frames, which are sometimes also referred to as packets, may include management frames, control frames, data frames, beacon frames, association frames, authentication frames, acknowledgement (ACK) frames, block ACK frames, and/or other types of frames. Each frame may include a frame header, body (e.g., after the header), and trailer (e.g., after the body). The header may include, for example, source address information identifying the transmitter of the frame, destination address information identifying the intended recipient of some or all of the frame, routing information, identifier information identifying one or more aspects of some or all of the frame (e.g., information identifying the type of frame), control information, etc. The body may include, for example, a data payload (e.g., a payload of voice data, video data, web browsing data, application data, etc.). The trailer may include checking information that helps to verify the frame to the recipient. The checking information may include a frame check sequence (FCS) or cyclic redundancy check (CRC) field, as examples.

Under a bidirectional communications link between AP 104 and STA 106, frames are conveyed both from AP 104 to STA 106 and from STA 106 to AP 104. STA 106 may transmit one or more ACK frames or block ACK frames to AP 104 to acknowledge the successful receipt of one or more frames transmitted by AP 104. AP 104 may transmit one or more ACK frames or block ACK frames to STA 106 to acknowledge the successful receipt of one or more frames transmitted by AP STA 106.

When a first device (e.g., AP 104 or STA 106) transmits wireless data to a second device (e.g., STA 106 or AP 104) over a medium, care should be taken to ensure that the second device correctly receives the wireless data transmitted by the first device. In addition, care should be taken to prevent an unauthorized third device (e.g., a so-called man-in-the-middle (MITM) attacker) from receiving the wireless data transmitted by the first device, to prevent the third device relaying the wireless data or transmitting modified or other wireless data to the second device (e.g., while tricking the second device into believing that the third device is actually the first device), and/or to prevent the third device from tricking the second device into transmitting additional wireless data to the third device rather than the first device.

To help mitigate these issues, a first device may integrity protect one or more fields of the frames of wireless data transmitted by the first device to a second device (e.g., an intended recipient). The second device may receive the integrity-protected frames from the first device. Upon receiving the integrity-protected frames, the second device may perform an integrity check (sometimes also referred to herein as an integrity verification or validation) to verify the integrity of the received integrity-protected frames. Verifying the integrity of the received integrity-protected frames may allow the second device to verify that it has correctly received all of the information in the integrity-protected frame transmitted by the first device and/or to verify that it has received the frame from the first device as opposed to an unauthorized third (e.g., MITM) device. The second device may also integrity protect one or more fields of the frames of wireless data that it transmits to the second device. The first device may then perform an integrity check on the integrity-protected frames transmitted by the second device.

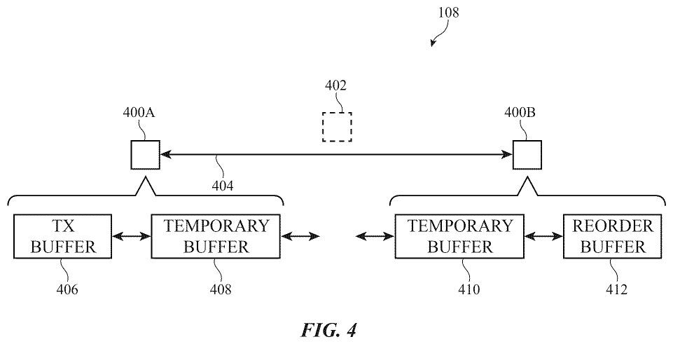

FIG. 4 is a diagram showing how first and second devices in wireless communication system 108 may convey wireless data with each other. As shown in FIG. 4, wireless communication system 108 may include at least a first device 400A (e.g., a STA 106 or AP 102/104 of FIG. 1) and a second device 400B (e.g., a STA 106 or AP 102/104 of FIG. 1). Devices 400A and 400B may convey wireless data with each other over wireless communication link 404. Embodiments in which wireless communication link 404 is implemented and maintained using an IEEE 802.11 protocol (e.g., 802.11bn or other versions of the 802.11 protocol) are described herein as an example.

Device 400A may integrity protect wireless data and may transmit the integrity-protected wireless data to device 400B over wireless communication link 404. The integrity-protected wireless data may include one or more frames (e.g., data frames). Device 400B may perform an integrity check to verify data from the integrity-protected frame received from device 400A. Device 400B may transmit an acknowledgement message of the received integrity-protected frame, such as a block acknowledgement (BA) frame, to device 400A over wireless communication link 404. If desired, device 400B may integrity protect the BA frame and device 400A may perform an integrity check to verify the integrity-protected BA frame received from device 400B. In this example, device 400A operates as a transmitting (TX) device and device 400B operates as a receiving (RX) device. This is illustrative and, at other times, device 400B may operate as a TX device whereas device 400A operates as an RX device. The integrity check may help to prevent a third device such as device 402 (e.g., a MITM device) from interfering with wireless communication link 404.

The transmitting device may utilize a transmit (TX) buffer and a temporary buffer to transmit data to the receiving device, which receives and processes the data in a temporary buffer and a reorder buffer. For example, when device 400A is acting as a transmitting device, device 400A processes transmitted data using TX buffer 406 and temporary buffer 408. When device 400B is acting as a receiving device, device 400B processes received data using temporary buffer 410 and reorder buffer 412. Device 400B may also have a TX buffer for use in transmitting data. Device 400A may also have a reorder buffer for use in receiving data.

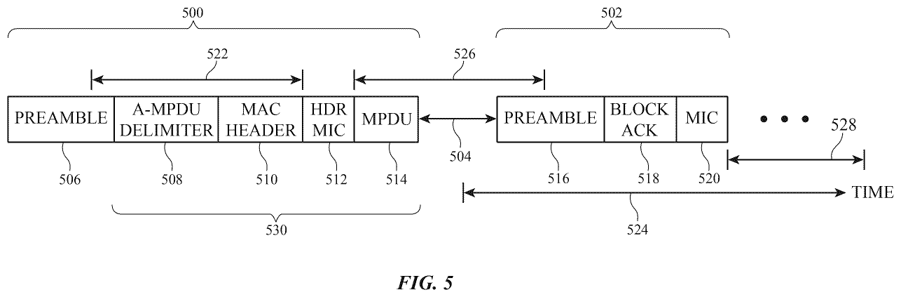

FIG. 5 is a timing diagram illustrating an exemplary frame 500 of integrity-protected wireless data transmitted by device 400A to device 400B and a corresponding integrity-protected BA frame 502 transmitted by device 400B to device 400A in response to frame 500. As shown in FIG. 5, frame 500 (e.g., a data frame) includes several fields (e.g., as specified by the corresponding IEEE 802.11 protocol). The fields of frame 500 may include a preamble such as preamble 506 (e.g., one or more preamble fields), followed by a delimiter field such as aggregated media access control protocol data unit (A-MPDU) delimiter 508 (sometimes also referred to herein as MPDU delimiter 508), followed by a header such as MAC header 510, followed by a MAC header (HDR) message integrity check (MIC) field such as HDR MIC 512, followed by a payload field such as media access control protocol data unit (MPDU) field 514. MPDU field 514 may also include a MIC (not shown in FIG. 5 for the sake of clarity) for the payload data within MPDU field 514.

FIG. 5 illustrates a simplest case in which frame 500 includes only a single MPDU for the sake of clarity. If desired, frame 500 may be a physical protocol data unit (PPDU) frame that includes multiple MPDUs. Each MPDU may be preceded by a corresponding MPDU delimiter (e.g., A-MPDU delimiter 508) in the PPDU frame. In these implementations, A-MPDU delimiter 508, MAC header 510, HDR MIC 512, and MPDU field 514 may form a single A-MPDU subframe 530 (delimiter 508, MAC header 510, HDR MIC 512, and MPDU field 514 are sometimes also referred to herein as A-MPDU subframe 530 or simply as subframe 530). The PPDU frame may include a series of multiple A-MPDU subframes. The MPDUs in the frame may each have a respective sequence number (SN) identifying the temporal position or order of the MPDUs within the frame. The MAC header of each subframe may identify the SN of its corresponding MPDU along with other header information.

Preamble 506 may include a PHY layer preamble for frame 500 and/or other preamble information. A-MPDU delimiter 508 may define the position and length of its corresponding MPDU field 514 within frame 500 (e.g., inside an aggregated frame in implementations where frame 500 is a PPDU frame). MAC header 510 includes MAC header information for MPDU field 514. As an example, MAC header 510 may include a header packet number (HDR PN) field. The HDR PN field may contain a unique value that is used to detect replay of the MAC header and in nonce of the integrity protection. HDR MIC 512 includes integrity protection check information for MAC header 510. HDR MIC 512 may, for example, be generated by inputting some or all of MAC header 510 to a cryptographic function such as a hashing function (e.g., HDR MIC 512 may be a hash value or other cryptographic function output generated based on the content of MAC header 510). MPDU field 514 may include any desired payload data for frame 500. MPDU field 514 may also include an additional MIC (not shown) that is generated by inputting some or all of the data payload of MPDU field 514 into a cryptographic function such as a hashing function. While not shown in FIG. 5 for the sake of clarity, frame 500 may also include a final (trailing) field after its last MPDU that includes a frame check sequence (FCS). The FCS may be a checksum or another value calculated based on all of the data in frame 500 (e.g., the FCS may be an output from a hashing function, checksum function, or other cryptographic function that takes as its input all of the data of frame 500).

Device 400B (FIG. 4) may generate and transmit BA frame 502 in response to receipt of frame 500. Device 400B may transmit BA frame 502 after a time period such as short interframe space (SIFS) 504 has elapsed since the end of frame 500 or MPDU field 514 (e.g., as specified by the IEEE 802.11 protocol). SIFS 504 may, for example, provide time for device 400B to process frame 500 and to respond with an ACK frame such as BA frame 502. Device 400B may transmit BA frame 502 using a predetermined or preconfigured duration, modulation coding scheme (MCS), and number of spatial streams (NSS).

As shown in FIG. 5, BA frame 502 includes several fields (e.g., as specified by the corresponding IEEE 802.11 protocol). BA frame 502 may include a preamble such as preamble 516, a block acknowledgement (ACK) message field such as block ACK 518, and a message integrity check field such as MIC 520. Preamble 516 may include a PHY layer preamble for BA frame 502 and/or other preamble information. Block ACK 518 may include information acknowledging, for device 400A, that device 400B has successfully received the corresponding MPDU field(s) 514 in frame 500. In implementations where frame 500 includes a single MPDU field 514, BA frame 502 may sometimes also be referred to simply as an ACK frame. In implementations where frame 500 includes multiple MPDU fields 514 (e.g., when frame 500 is a PPDU frame), block ACK 518 may acknowledge the successful receipt of multiple MPDUs from frame 500 at device 400B.

MIC 520 includes integrity protection check information for block ACK 518. MIC 520 may, for example, be generated by inputting some or all of block ACK 518 to a cryptographic function such as a hashing function (e.g., MIC 520 may be a hash value or other cryptographic function output generated based on the content of block ACK 518). Device 400A is sometimes also referred to herein as the transmitting or transmitter (TX) device of frame 500 and/or the recipient or receiver (RX) device of BA frame 502. Device 400B is sometimes also referred to herein as the TX device of BA frame 502 and/or the RX device of frame 500.

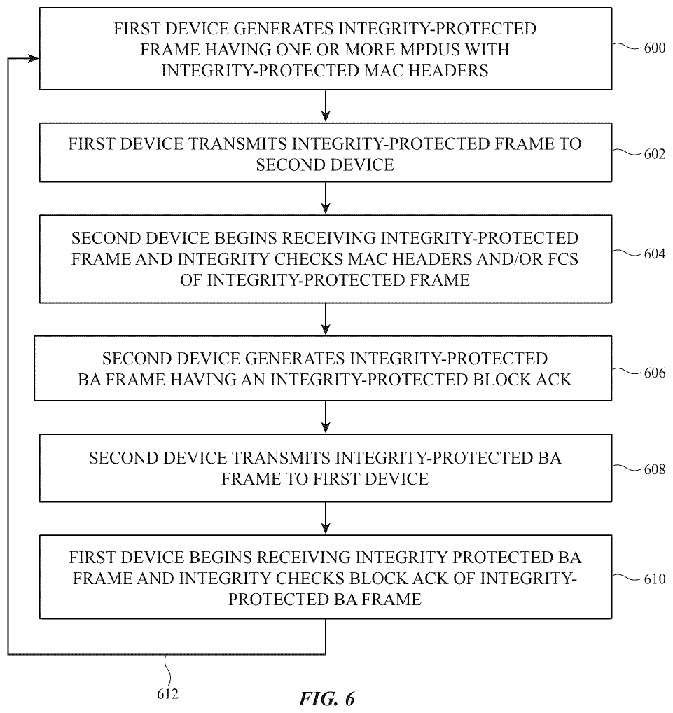

FIG. 6 is a flow chart of illustrative operations involved in conveying frame 500 and BA frame 502 of FIG. 5 between devices 400A and 400B of FIG. 4. At operation 600 of FIG. 6, device 400A may generate an integrity-protected frame such as frame 500. Device 400A may integrity-protect the frame by generating a respective HDR MIC 512 based on the MAC header 510 of each MPDU field 514 in frame 500, for example. Device 400A may then include HDR MICs 512 in frame 500. Device 400A may also integrity-protect the frame by generating an additional MIC for the data payload of each MPDU field 514 and inserting the additional MIC into or adjacent to each MPDU field. If desired, device 400A may combine a HDR MIC with the corresponding additional MIC for a given MPDU field to produce a combined MIC that is inserted into the frame. Device 400A may also generate an FCS based on the content of frame 500 and may include the FCS in frame 500 (e.g., in a trailing field of frame 500). If desired, device 400A may insert one or more padding fields into the frame to help accommodate processing delays.

At operation 602, device 400A may transmit frame 500 to device 400B.

At operation 604, device 400B may begin receiving frame 500 from device 400A. Device 400B may integrity check (e.g., may verify the integrity of) the received frame 500. This may sometimes also be referred to herein as validating the integrity of frame 500, validating the integrity protection of frame 500, verifying the integrity of frame 500, verifying the integrity protection of frame 500, checking the integrity of frame 500, or checking the integrity protection of frame 500. If desired, the integrity check may contain a replay detection operation. Replay detection may be performed to ensure that the HDR PN values are increasing over time (e.g., by comparing a HDR PN value to a previous HDR PN value and determining whether the newer HDR PN value is greater than the previous HDR PN value). The integrity check may also include computing, calculating, or generating a HDR MIC for each MAC header 510 in the received frame (e.g., using the same hashing function or cryptographic function used by device 400A to generate HDR MICs 512 with the corresponding MAC header 510 as an input to the function) and comparing the calculated HDR MIC to the HDR MICs 512 included in frame 500. If desired, this may also include computing, calculating, or generating an additional MIC for the data payload in each MPDU field 514 of the received frame and comparing the calculated additional MIC(s) to the corresponding additional MIC(s) of the MPDU field(s) 514 as included in frame 500. If desired, device 400B may also generate an FCS for the received frame 500 and may compare the generated FCS to an FCS included in frame 500. Device 400B successfully verifies/validates the integrity of the received frame 500 (e.g., the integrity check is successful) if/when each of the calculated HDR MICs matches the corresponding HDR MICs 512 included in frame 500 and/or each of the calculated additional MICs matches the corresponding additional MICs in frame 500. If one of the calculated HDR MICs does not match the corresponding HDR MIC 512 included in frame 500 and/or one of the calculated additional MICs does not match the corresponding additional MIC included in frame 500, device 400B does not verify the integrity of received frame 500 (e.g., the integrity check is unsuccessful/failed, the frame is identified as invalid or unverified, etc.). Device 400B may take appropriate action when the integrity check is successful or unsuccessful.

At operation 606, device 400B may generate an integrity-protected BA frame such as BA frame 502. Device 400B may integrity-protect the BA frame by generating MIC 520 based on block ACK 518 and including MIC 520 in BA frame 502. If desired, device 400B may insert one or more padding fields into the BA frame to help accommodate processing delays.

At operation 608, device 400B may transmit the integrity-protected BA frame to device 400A. Device 400B may perform operations 606 and/or 608 prior to or concurrently with operation 604 if desired.

At operation 610, device 400A may begin receiving BA frame 502 from device 400B. Device 400A may integrity check (e.g., may verify the integrity of) the received BA frame 502. This may sometimes also be referred to herein as validating the integrity of BA frame 502, validating the integrity protection of BA frame 502, verifying the integrity of BA frame 502, verifying the integrity protection of BA frame 502, checking the integrity of BA frame 502, or checking the integrity protection of BA frame 502. This may include computing, calculating, or generating a MIC for block ACK 518 in the received BA frame (e.g., using the same hashing function or cryptographic function used by device 400B to generate MIC 520 with the corresponding block ACK 518 as an input to the function) and comparing the generated MIC to the MIC 520 included in BA frame 502. The integrity check may also optionally include soliciting frame verification, described in greater detail below. Device 400A successfully verifies/validates the integrity of the received BA frame 502 (e.g., the integrity check is successful) if/when the generated MIC matches the MIC 520 included in BA frame 502. If the generated MIC does not match the MIC 520 included in BA frame 502, device 400A does not verify the integrity of received frame 500 (e.g., the integrity check is unsuccessful). Device 400A may take appropriate action when the integrity check is successful or unsuccessful. Processing may then loop back to operation 600 via path 612 as device 400A continues to transmit wireless data to device 400B. Device 400A may perform operation 600 after or concurrently with a subsequent iteration of operation 600 if desired.

Integrity checking frame 500 and BA frame 502 (FIG. 5) in this way may help to protect against MITM attacks by other devices such as device 402 of FIG. 4 and may help to optimize wireless communication between devices 400A and 400B. MAC header integrity protection (e.g., HDR MICs 512 in frame 500) may, for example, help to ensure that an attacker (e.g., device 402) cannot change a STA 106 (FIG. 1) to receive PPDUs with excessive bandwidth (BW) or NSS (e.g., via operating mode indication (OMI) A-Control) and/or may help to ensure that an attacker cannot cause AP 102/104 (FIG. 1) to believe that STA 106 is incorrectly in a power save or active mode, which could otherwise cause frame loss or a lack of frame transmission (e.g., via the STA's Power Management field). On the other hand, BA frame integrity protection (e.g., MIC 520 in BA frame 502) may help to ensure that the SN of devices 400A and 400B are synchronized. For example, if device 400B is expecting an excessively high SN, device 400B can drop received frames with smaller SNs. In addition, if device 400B has a hole in its reorder buffer, device 400B may not properly forward received frames to its corresponding software application or to the network 100 (FIG. 1), which can cause transmission delays.

Consider one example of a MITM attack performed by device 402 of FIG. 4. In this example, device 402 intercepts a frame 500 transmitted by device 400A (e.g., a frame having MPDUs with sequence numbers (SN) 1, 2, 3, and 4), device 402 modifies the data from frame 500 before transmitting the modified data to device 400B (e.g., a frame having only MPDUs with sequence numbers 1 and 2 but not sequence numbers 3 and 4 from the data transmitted by device 400A), and device 400A does not receive a BA frame. Integrity protection and checking can help to mitigate this type of attack.

Integrity checking frame 500 and BA frame 502 may also require processing delays for device 400A and 400B. For example, returning to FIG. 5, device 400A may require a time period 522 to generate (e.g., calculate, compute, etc.) HDR MIC 512 for MAC header 510 (e.g., at operation 600 of FIG. 6). As another example, device 400B may require a time period 526 following receipt of the end of MAC header 510 to verify HDR MIC 512 (e.g., at operation 604 of FIG. 6). As yet another example, device 400B may require a time period 524 to generate (e.g., calculate, compute, etc.) MIC 520 for block ACK 518 (e.g., at operation 606 of FIG. 6). As still another example, device 400A may require a time period 528 following receipt of the end of MIC 520 to verify MIC 520 (e.g., at operation 610 of FIG. 6).

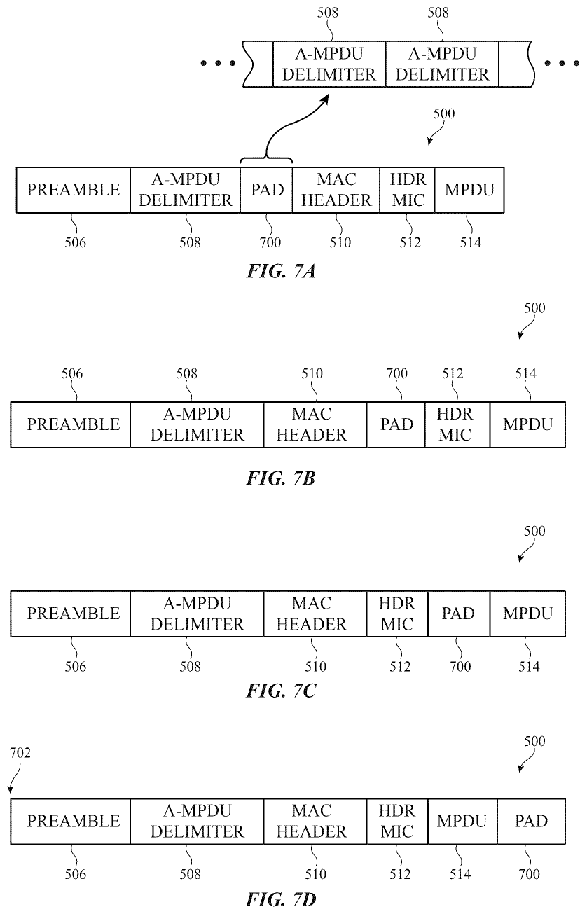

If desired, frame 500 and/or BA frame 502 may include one or more padding fields that help to help accommodate these processing delays. FIGS. 7A-D show four examples of padding fields that device 400A may include in frame 500. As shown in the first example of FIG. 7A, device 400A may generate a frame 500 that includes a padding field such as padding (PAD) 700 between A-MPU delimiter 508 and MAC header 510. In general, padding 700 may include any desired sequence of one or more padding bits. As one example, padding 700 may include one or more repetitions of A-MPDU delimiter 508 (e.g., there may be two or more copies of A-MPDU delimiter 508 between preamble 506 and MAC header 510).

In another example, as shown in FIG. 7B, padding 700 may be between MAC header 510 and HDR MIC 512 in frame 500. In yet another example, as shown in FIG. 7C, padding 700 may be inserted between HDR MIC 512 and MPDU field 514 in frame 500. In a further example, as shown in FIG. 7D, padding 700 may be appended to the end of MPDU field 514 and/or frame 500. Padding 700 of FIGS. 7A-7C may include any desired sequence of one or more padding bits or symbols (e.g., orthogonal frequency division multiplexing (OFDM) symbols that each have a 4 us duration, a 12 us duration, or another duration as specified by the communications protocol). If desired, padding 700 may be appended to the beginning of preamble 506 in some cases (e.g., at location 702). If desired, frame 500 may include padding 700 at two or more of the locations shown in FIGS. 7A-7D. As examples, padding 700 may include one or more repetitions of A-MPDU delimiter 508, repetitions of one or more other fields of frame 500, empty or null fields, a field or series of bits or symbols defined by the communications protocol as being intended or reserved for padding, etc. Padding 700 may, for example, allow more time for device 400A to generate HDR MIC 512 for MAC header 510 when generating and transmitting frame 500 and/or for device 400B to verify HDR MIC 512 in the received frame 500.

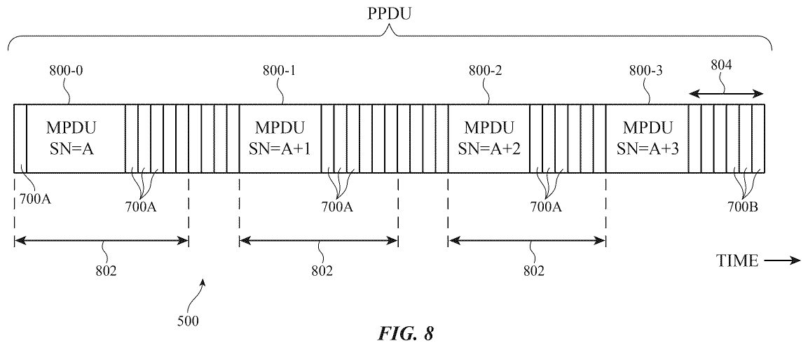

FIG. 8 is a diagram showing one example in which frame 500 is a PPDU frame having multiple MPDUs. As shown in FIG. 8, frame 500 may include a set of MPDU fields 800. Each MPDU field 800 may include a respective MPDU field 514 of FIG. 5 and may, if desired, be associated with a different respective subframe (e.g., subframe 530 of FIG. 5). If desired, each MPDU field 800 may also include one or more of the other fields 506, 508, 510, and 512 of FIG. 5 before the corresponding MPDU field 514.

Each MPDU field 800 has a corresponding SN specifying the order of the MPDU fields within frame 500. In the example of FIG. 8, frame 500 has four MPDU fields 800, including a first MPDU field 800-0 with SN=A, a second MPDU field 800-1 with SN=A+1, a third MPDU field 800-2 with SN=A+2, and a fourth MPDU 800-3 with SN=A+3. MPDU fields 800-0 through 800-3 may also have respective increasing HDR PN values. This is illustrative and, in general, frame 500 may have any desired number of MPDU fields 800.

Frame 500 may include padding 700 before and/or after each MPDU field 800. If desired, frame 500 may have different paddings 700 with different characteristics and/or including different padding bits and/or symbols at different locations within the frame. For example, there may be a first set of padding fields 700A and a second set of padding fields 700B in frame 500. Padding fields 700A may, for example, occur before and after each MPDU field 800 in frame 500 except for the final MPDU field 800 in frame 500 (e.g., MPDU field 800-3). Padding fields 700B may occur after the final MPDU field 800 in frame 500 (e.g., MPDU field 800-3). In the example of FIG. 8, there is a single padding field 700A before MPDU field 800-0 and a set of ten padding fields 700A between MPDU fields 800-0 and 800-1 and between MPDU fields 800-1 and 800-2, six padding fields 700A between MPDU fields 800-2 and 800-3, and six padding fields 700B after MPDU field 800-3. This is illustrative and, in general, frame 500 may include any desired number of padding fields 700A and 700B.

In some implementations, each padding field 700A may include a duplicated A-MPDU delimiter 508 (FIG. 5) (e.g., padding fields 700A may be duplicates of the same MPDU delimiter). A duplicated A-MPDU delimiter may be, for example, a zero-length A-MPDU subframe with its end of frame (EOF) bit set to 0. In some implementations, each padding field 700B may include EOF padding bits (e.g., a zero length A-MPDU subframe with its EOF bit set to 1). There may be sufficient padding fields 700B (e.g., EOF bits in frame 500) to meet a minimum EOF padding duration 804 for frame 500. Padding fields 700A may help to ensure that a minimum MPDU start spacing 802 exists between the beginning of each MPDU field 800 in frame 500 and the beginning of the subsequent MPDU field 800 in frame 500. Device 400A may adjust or re-configure the number of padding fields 700A and/or 700B to allow more or less time for device 400A to generate frame 500 and/or for device 400B to integrity check frame 500.

Minimum MPDU start spacing 802 represents the time in which one MPDU field 800 may be transmitted by device 400A, regardless of the size of the MPDU field. Additional padding fields 700A (e.g., A-MPDU subframe headers, MPDU delimiters, etc.) may be added to ensure that the next MPDU field 800 begins only after minimum MPDU start spacing 802. If MPDU transmission takes longer than minimum MPDU start spacing 802 then device 400A may forego the inclusion of padding fields, as padding is not needed. The added time from padding fields 700A and 700B may be in units of symbols, for example.

Minimum EOF padding duration 804 is the amount of time when padding is transmitted at the end of or after frame 500. The EOF padding duration (e.g., the number of padding fields 700B) may increase the number of symbols that need to be transmitted at the end of or after the data frame. The receiver (e.g., device 400B) may use this time to integrity check the data frame. The receiver may also use this time to create the integrity-protected BA frame 502 (FIG. 5).

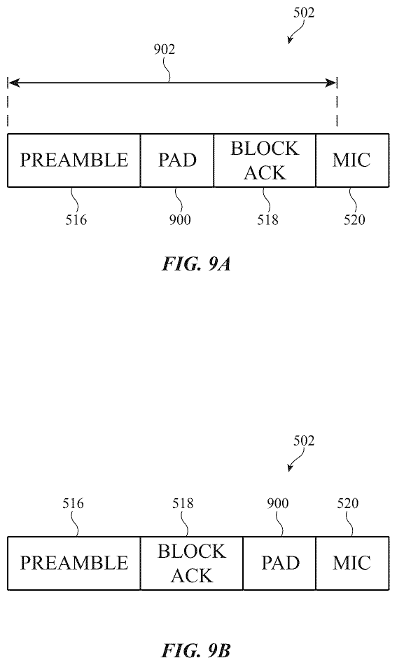

FIGS. 9A and 9B show two examples of padding fields that device 400B may include in BA frame 502 of FIG. 5. As shown in the example of FIG. 9A, device 400B may generate a BA frame 502 that includes a padding field such as padding 900 between preamble 516 and block ACK 518. In this example, padding 900 may include similar padding as padding fields 700A of FIG. 8 (e.g., one or more duplicated MPDU delimiters) or may include other padding. In another example, as shown in FIG. 9B, padding 900 may be inserted between block ACK 518 and MIC 520. If desired, similar padding to padding 900 may also be included within block ACK 518 (e.g., as additional Per Association Identifier (AID) fields). If desired, BA frame 502 may include padding 900 at two or more of these locations. In general, padding 900 may include similar padding as padding fields 700A of FIG. 8 (e.g., a duplicated MPDU delimiter), one or more AID traffic identifier (TID) Info fields that are not used by any STA 106, or other padding bits or symbols. If desired, the receiver may help to configure the minimum EOF padding duration 804 used to transmit frame 500 (FIG. 8) to allow the receiver sufficient time to calculate and generate the BA frame.

Device 400B may transmit BA frame 502 to a receiver of the BA frame (e.g., device 400A). BA frame 502 may have a minimum duration 902. Minimum duration 902 plus the minimum EOF padding duration 804 (FIG. 8) may signal to an AP the minimum duration of the BA frame that the receiver should consider to receive. If the BA frame includes relatively large Per AID fields, then this duration may be exceeded. If the AP triggers uplink (UL) BA frames by sending a corresponding trigger frame, then the UL reservation unit duration for the BA frame may be at least the minimum duration 902 plus minimum EOF padding duration 804 (FIG. 8). Minimum duration 902 may be replaced with the minimum EOF padding time, for example. In this case, all extra time is allocated to frame 500. If desired, extra padding time may be added after the end of MIC 520 in BA frame 502 (e.g., as shown by padding 900 of FIG. 9B). This time is used by the transmitter (e.g., device 400A) to verify the integrity of BA frame 502 and to check whether to continue data transmissions.

Padding 700 may be added to frame 500 and/or padding 900 may be added to BA frame 502 (e.g., before block ACK 518, after block ACK 518, and/or within block ACK 518 as additional Per AID fields) to accommodate integrity protection and integrity check processing delays. When padding 700 is added to the end of frame 500 (see, e.g., FIGS. 7D and 8), the padding duration is configured in the association and the padding is present in all transmitted A-MPDUs. This may require additional setup signaling. As the padding is always present, this type of padding always involves additional overhead. On the other hand, when padding 900 is added to BA frame 502, the BA frame transmitter (e.g., device 400B) may add the padding as per-Association Identifier (AID) padding fields if/when the calculation of MIC 520 requires additional time. Padding 900 may be, for example, one or more AID TID Info fields that are not used by any STA 106. This implementation does not require any signaling overhead to set up and the BA frame transmitted may simply apply the padding when needed.

Consider an example in which device 400A performs transmit opportunity (TXOP) continuation after receipt of a BA frame 502. In these situations, device 400A does not necessarily know whether the true (intended) receiver (e.g., device 400B) has received its transmitted frame 500 until device 400A has verified the integrity of the corresponding BA frame 502 transmitted by device 400B. In this situation, device 400A may verify the integrity of BA frame 502 (e.g., having padding 900 at the trailing end of the BA frame as shown in FIG. 9B) before or after continuing TXOP by transmitting additional frames 500 to device 400B.

In implementations where device 400A begins to transmit additional frames 500 regardless of whether device 400A has validated the integrity of BA frame 502, device 400A estimates the duration of the next PPDU without ensuring that frames are received by the intended receiver. If an attacker (e.g., device 402 of FIG. 4) transmitted the BA frame, the next PPDU duration may be allocated incorrectly, leading to communication errors. By adding padding 900 to BA frame 502, device 400B may allow more time for device 400A to verify (validate) the integrity of BA frame 502. By verifying the integrity of BA frame 502, device 400A knows that its transmitted frame 500 was received by the true (intended) receiver (device 400B) as well as the number of MPDUs received by the true receiver. On the other hand, padding 900 adds transmission overhead for device 400B.

The header(s) in frame 500 may include a corresponding Header (HDR) Packet Number (PN) (HDR PN), a time synchronization function (TSF) component (e.g., specifying the time when the corresponding preamble is to begin transmission), and HDR MIC (e.g., HDR MIC 512 of FIG. 5). HDR PN may include a unique counter value that is incremented by one for each integrity-protected header transmitted by device 400A. Device 400B may use several protection mechanisms to prevent the reception of fake data from a MITM (e.g., device 402) and the transmission of a BA frame as a response to the receipt of fake data. For example, device 400B may perform an address and FCS check. Device 400B may transmit BA frame 502 if frame 500 is properly addressed to device 400B and the FCS computed at device 400B in response to the received frame 500 matches the FCS field of the received frame 500. Additionally or alternatively, device 400B may check the header PN(s) and may transmit BA frame 502 if the MPDU is not replayed. Additionally or alternatively, device 400B may check the header TSF(s) and HDR PNs and may transmit BA frame 502 if the TSF is within a predetermined time period (e.g., approximately 256 us) and the HDR PN increasing counter value together with the TSF (if present) have a value that is larger than a previously received value for a correctly integrity protected frame. Additionally or alternatively, device 400B may calculate the HDR MIC(s) and may transmit BA frame 502 if the calculated HDR MIC(s) match the header MIC(s) included in frame 500. Additionally or alternatively, device 400B may calculate the MIC for data payload(s) in frame 500 and may transmit BA frame 502 if the calculated MIC(s) match the MIC(s) for the data payload(s) included in frame 500. The integrity check at device 400B may occur before or after device 400B transmits BA frame 502, with differing implications for how device 400A and 400B process the transmitted and received data.

In general, when device 400B transmits BA frame 502 regardless of MAC header integrity validation for frame 500, the A-MPDU does not need extra padding. Device 400B may transmit the BA frame when the MAC headers A1 and A2 match and device 400B has correctly received at least one MPDU (e.g., the FCS matches). On the other hand, when device 400B transmits BA frame 502 only if/when MAC header integrity is validated, extra padding may be needed to accommodate the MAC header integrity check (sometimes also referred to herein as MAC header integrity validation). Device 400B may transmit the BA frame when MAC headers A1 and A2 match and device 400B receives at least one MPDU, successfully verifies the integrity protection of its MAC header, and successfully verifies that it has correctly received the MPDU (e.g., the FCS matches).

Buffers on device 400A and device 400B (e.g., buffers 406-412 of FIG. 4) may be adapted to handle the transmission, reception, and validation of frame 500 and BA frame 502. For example, when device 400A has data to transmit to device 400B, device 400A may select one or more MPDUs for transmission to device 400B. Device 400A may aggregate the MPDUs into frame 500 (e.g., at TX buffer 406 and/or temporary buffer 408 of FIG. 4). Device 400A may integrity protect the MPDUs and/or frame. For example, device 400A may integrity protect the MAC headers 510 of the MPDU fields 514 in frame 500 by generating corresponding HDR MICs 512 and inserting HDR MICs 512 into frame 500. Device 400A may also encrypt the data payloads of the MPDUs and/or may generate and insert additional MICs of the data payloads of the MPDUs.

Device 400B may receive frame 500 and may store frame 500 in temporary buffer 410. Device 400B may perform an integrity check on the MPDUs stored in temporary buffer 410. Device 400B may, for example, only acknowledge a received MPDU (e.g., in a corresponding BA frame 502) when the MPDU has all of the following: (a) matching MAC headers A1 and A2, (b) MAC header numbers (MHNs) that are in increasing order, and (c) payloads with correct FCSs. Device 400B may update reorder buffer 412 (FIG. 4) to only include MPDUs or frames 500 from temporary buffer 410 that are valid (e.g., that pass the integrity check). For example, Device 400B may validate the integrity of MPDUs in temporary buffer 410 by performing one or more of the following: (i) validating the integrity of the MAC header for each MPDU in temporary buffer 410 (e.g., by calculating a HDR MIC from the MAC header and comparing it to the corresponding HDR MIC 512 received in frame 500 and stored in the temporary buffer), (ii) decrypting the data payload for each MPDU and integrity checking the decrypted data payload, and (iii) checking whether reorder buffer 412 already contains the PN of the corresponding frame 500. Device 400A may update its TX buffer 406 (FIG. 4) based on integrity checked BA frames 502 received from device 400B. Device 400A may, for example, receive a BA frame 502 from device 400B and may store the BA frame in temporary buffer 408 (FIG. 4). Device 400A may then verify the integrity of the BA frame in temporary buffer 408 (e.g., may check whether the bitmap of the BA frame matches the currently transmitted MPDUs in temporary buffer 408). If both conditions are met, device 400A may update its TX buffer 406 based on the now-verified (integrity-checked) BA frame 502.

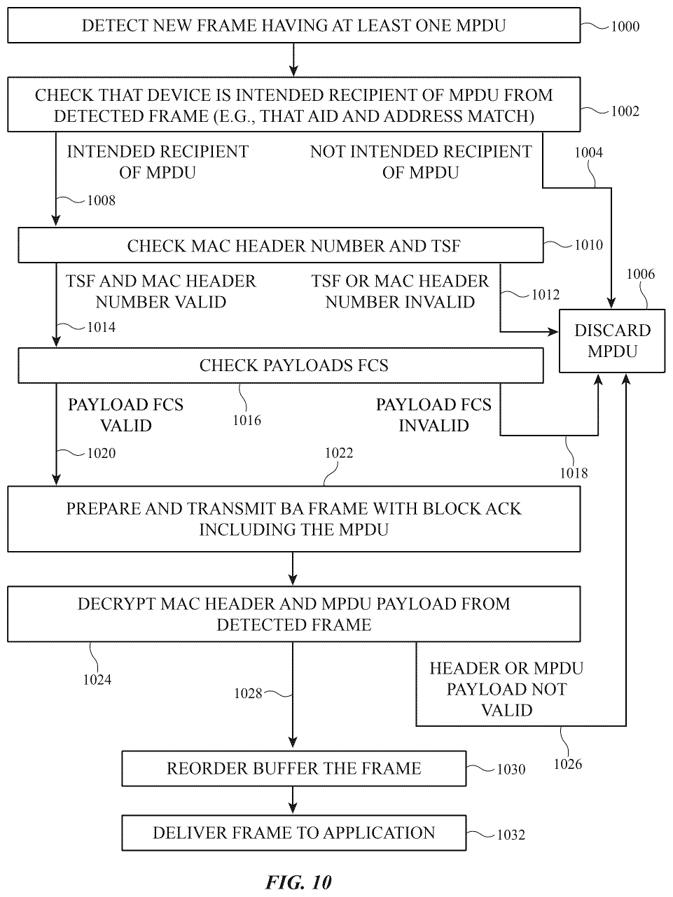

FIGS. 10-12 are flow charts of illustrative operations that may be performed by device 400B to integrity check a frame 500 transmitted by device 400A before or after device 400B transmits the corresponding BA frame 502 to device 400A. The operations of FIGS. 10-12 may, for example, be performed while processing operation 604 and 606 of FIG. 6.

FIG. 10 is a flow chart of operations that may be performed by device 400B in implementations where device 400B integrity checks the MAC header MIC (e.g., HDR MIC 512 of FIG. 5) and the corresponding FCS of frame 500 after generating and transmitting BA frame 502.

At operation 1000, device 400B may detect (e.g., may receive and begin attempting to decode/demodulate) a frame 500 transmitted by device 400A. Frame 500 includes at least one MPDU field 514 (FIG. 5). The remaining operations of FIG. 10 may be performed on a given MPDU field 514 from frame 500. In situations where frame 500 includes multiple MPDU fields 514 (e.g., for MPDU fields 800 in a single PPDU as shown in FIG. 8), the operations of FIG. 10 may be repeated for each of the MPDUs in the received frame. Device 400B may temporarily store the MPDU at temporary buffer 410 (FIG. 4) for further processing.

At operation 1002, device 400B may check, verify, validate, identify, and/or otherwise determine whether device 400B is the intended recipient of the MPDU field 514 from frame 500. This may include, for example, determining whether the AID and destination address of the MPDU stored on the temporary buffer (e.g., as identified by one or more header fields of the MPDU) are associated with device 400B or another recipient device. If/when device 400B is not the intended recipient of the MPDU (e.g., when the AID and/or address do not match), processing may proceed to operation 1006 via path 1004.

At operation 1006, device 400B may discard (delete) the MPDU from the temporary buffer and processing may loop back from operation 1006 to operation 1002 to process additional MPDUs of the detected frame 500. Alternatively, processing may loop back from operation 1006 to operation 1000 to process additional frames 500 received from device 400A. If/when device 400B is the intended recipient of the MPDU (e.g., when the AID and address match), processing may proceed from operation 1002 to operation 1010 via path 1008.

At operation 1010 (e.g., responsive to device 400B being the intended recipient of the MPDU), device 400B may check, verify, and/or validate a MAC header number (MHN) and TSF of the MPDU stored at the temporary buffer. The MHN and the TSF may, for example, be identified by or included within the MAC header 510 (FIG. 5) of the MPDU. Device 400B may check the MHN and TSF by, for example, determining whether the MHN is a duplicate MHN and whether the TSF falls within a predetermined range. Device 400B may determine or identify that the MHN is valid if/when the MHN is not a duplicate MHN and may determine that the TSF is valid if/when the TSF is within a predetermined time range. On the other hand, device 400B may determine or identify that the MHN is invalid if/when the MHN is a duplicate MHN and may determine that the TSF is invalid if/when the TSF is outside the predetermined time range. If/when one or both of the MHN and TSF are invalid, processing proceeds to operation 1006 via path 1020 and the MPDU may be discarded. If/when the MHN and the TSF are valid, processing proceeds from operation 1010 to operation 1016 via path 1014.

At operation 1016 (e.g., responsive to device the MPDU having a valid MHN and TSF), device 400B check, verify, and/or validate a payload FCS of the MPDU stored at the temporary buffer. This may include calculating an FCS based on the payload of the MPDU and comparing the calculated FCS to an FCS field of the MPDU. Device 400B may determine or identify that the FCS is valid when the calculated FCS matches the FCS identified by the FCS field of the MPDU. Device 400B may determine or identify that the FCS is invalid when the calculated FCS does not match the FCS identified by the FCS field of the MPDU. If/when the FCS is invalid, processing proceeds to operation 1006 via path 1018 and the MPDU may be discarded. If/when the FCS is valid, processing proceeds from operation 1016 to operation 1022 via path 1020.

At operation 1022 (e.g., responsive to the MPDU having a valid FCS), device 400B may prepare (generate) a BA frame 502 having a block ACK 518 (FIG. 5) that includes and/or otherwise identifies the corresponding MPDU received in frame 500 (e.g., the MPDU as checked at operations 1008-1016). Device 400B may transmit BA frame 502 to device 400A.

At operation 1024 (e.g., after transmission of BA frame 502), device 400B may decrypt the MAC header 510 (FIG. 5) and the data payload of the MPDU from the detected frame 500. This may include checking, verifying, and/or validating the HDR MIC 512 of the MPDU as well as checking, verifying, and/or validating a MIC field of the data payload of the MPDU.

Device 400B may validate HDR MIC 512 by calculating a header MIC based on the MAC header 510 of the MPDU (e.g., by applying the same hashing function or cryptographic function to MAC header 510 as applied by device 400A when generating HDR MIC 512) and by comparing the calculated header MIC to the HDR MIC 512 of the MPDU as included in the received frame 500 (e.g., device 400B may determine that HDR MIC 512 is valid when the calculated header MIC matches the HDR MIC 512 included with the MPDU and may determine that HDR MIC 512 is invalid when the calculated header MIC does not match the HDR MIC 512 included with the MPDU).

Device 400B may validate the MIC field of the data payload of the MPDU by calculating a MIC based on the data payload of the MPDU (e.g., by applying the same hashing function or cryptographic function to the data payload as applied by device 400A when generating the MPDU) and comparing the calculated MIC to the MIC for the data payload as included with the MPDU in the detected frame 500 (e.g., device 400B may determine that MIC for the data payload is valid when the calculated MIC matches the MIC for the data payload as included with the MPDU and may determine that the MIC for the data payload is invalid when the calculated MIC does not match the MIC for the data payload as included with the MPDU).

If/when device 400B determines that HDR MIC 512 is invalid, that the MIC for the data payload is invalid, or that device 400B is otherwise unable to recover or decrypt the data payload, processing may proceed to operation 1006 via path 1026. If/when device 400B determines that HDR MIC 512 is valid, that the MIC for the data payload is valid, and device 400B is able to recover or decrypt the data payload, processing proceeds to operation 1030 via path 1028.

At operation 1030, device 400B may reorder buffer the MPDU from the detected frame 500. This may include passing the MPDU from temporary buffer 410 to reorder buffer 412 (FIG. 4). Recorder buffer 412 may reorder stored MPDUs (e.g., in the correct time order as identified by the SN of the MPDUs transferred onto reorder buffer 412 from temporary buffer 410).

At operation 1032, the reorder buffer 412 on device 400B (FIG. 4) may deliver the MPDU(s) stored on reorder buffer 412 to one or more software applications running on device 400B for further processing (e.g., device 400B may pass the stored MPDU(s) up the protocol stack to an applications processor on device 400B).

The example of FIG. 10 in which device 400B transmits BA frame 502 before checking the MIC of the data payload and the HDR MIC 512 for the MAC header 510 in the MPDU stored at temporary buffer 410 is illustrative and non-limiting. If desired, device 400B may check the HDR MIC 512 for the MAC header 510 of the MPDU prior to transmitting BA frame 502.

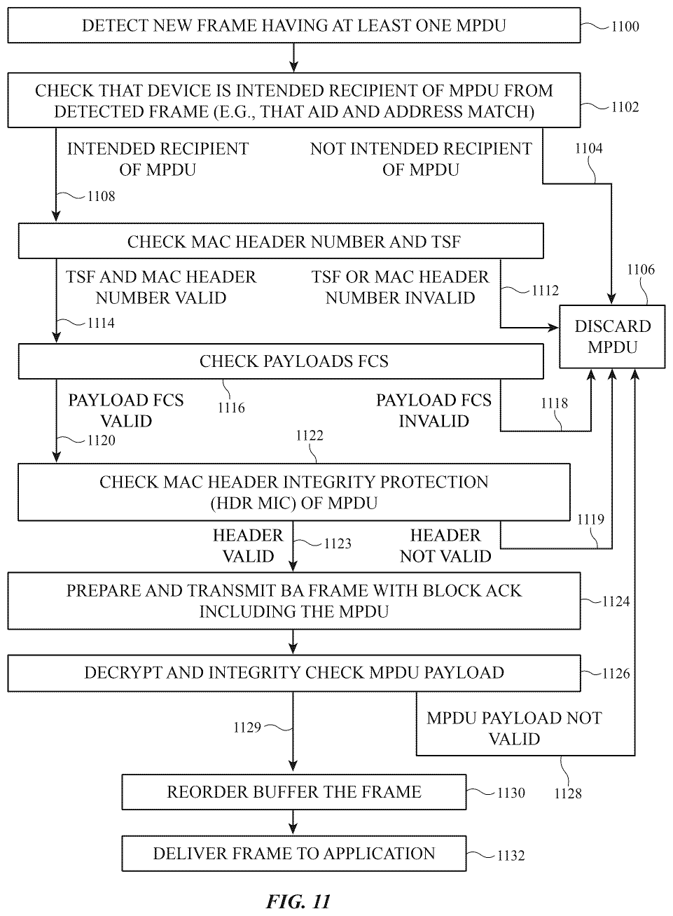

FIG. 11 is a flow chart of illustrative operations that may be performed by device 400B in implementations where device 400B integrity checks MAC header 510 of the MPDU prior to transmitting BA frame 502. Operations 1100-1116 of FIG. 11 are the same as operations 1000-1016 of FIG. 10, respectively. Description of operations 1100-1116 of FIG. 11 have therefore been omitted for the sake of brevity.

At operation 1122 (e.g., prior to transmitting BA frame 502 and responsive device 400B determining that the FCS payload is valid), device 400B may validate HDR MIC 512 by calculating a header MIC based on the MAC header 510 of the MPDU stored on the temporary buffer and by comparing the calculated header MIC to the HDR MIC 512 included with the MPDU in the detected frame 500. Device 400B may determine that HDR MIC 512 is valid when the calculated header MIC matches the HDR MIC 512 included with the MPDU and may determine that HDR MIC 512 is invalid when the calculated header MIC does not match the HDR MIC 512 included with the MPDU.

If/when device 400B determines that HDR MIC 512 is invalid, processing may proceed to operation 1106 via path 1119. If/when device 400B determines that HDR MIC 512 is valid, processing proceeds to operation 1124 via path 1123. At operation 1124 (e.g., responsive to the MPDU having a valid HDR MIC 512), device 400B may prepare (generate) a BA frame 502 having a block ACK 518 (FIG. 5) that includes and/or otherwise identifies the corresponding MPDU received in frame 500 (e.g., the MPDU as checked at operations 1102-1122). Device 400B may transmit BA frame 502 to device 400A.

At operation 1126 (e.g., after transmission of the BA frame), device 400B may validate the MIC field of the data payload of the MPDU by calculating a MIC based on the data payload of the MPDU and comparing the calculated MIC to the MIC for the data payload as included with the MPDU in the detected frame 500. Device 400B may determine that MIC for the data payload is valid when the calculated MIC matches the MIC for the data payload as included with the MPDU and may determine that the MIC for the data payload is invalid when the calculated MIC does not match the MIC for the data payload as included with the MPDU.

If/when device 400B determines that the MIC for the data payload is invalid, processing may proceed to operation 1106 via path 1128. If/when device 400B determines that the MIC for the data payload is valid, and device 400B may recover or decrypt the data payload and processing proceeds to operation 1130 via path 1129. Operations 1130 and 1132 of FIG. 11 are the same as operations 1030 and 1032 of FIG. 10, respectively. Description of operations 1130 and 1132 have therefore been omitted for the sake of brevity.

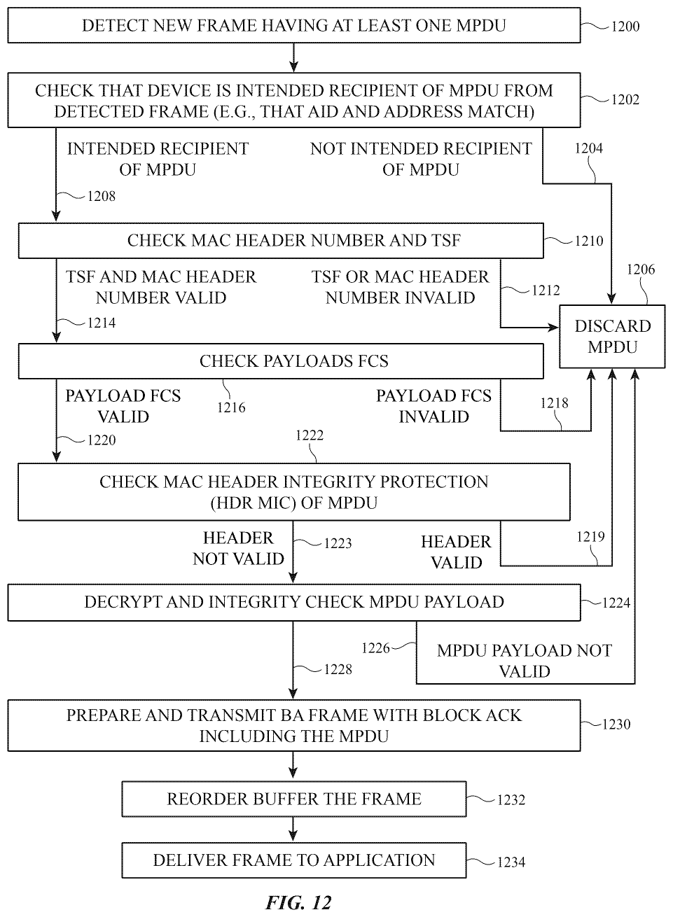

If desired, device 400B may check both the HDR MIC 512 for the MAC header 510 of the MPDU and the MIC for the data payload of the MPDU prior to transmitting BA frame 502. FIG. 12 is a flow chart of illustrative operations that may be performed by device 400B in implementations where device 400B integrity checks both MAC header 510 and the data payload of the MPDU prior to transmitting BA frame 502. Operations 1200-1216 of FIG. 12 are the same as operations 1000-1016 of FIG. 10, respectively. Description of operations 1200-1216 of FIG. 12 have therefore been omitted for the sake of brevity.

At operation 1222 (e.g., prior to transmitting BA frame 502 and responsive device 400B determining that the FCS payload is valid), device 400B may validate HDR MIC 512 by calculating a header MIC based on the MAC header 510 of the MPDU stored on the temporary buffer and by comparing the calculated header MIC to the HDR MIC 512 included with the MPDU in the detected frame 500. Device 400B may determine that HDR MIC 512 is valid when the calculated header MIC matches the HDR MIC 512 included with the MPDU and may determine that HDR MIC 512 is invalid when the calculated header MIC does not match the HDR MIC 512 included with the MPDU.

If/when device 400B determines that HDR MIC 512 is invalid, processing may proceed to operation 1206 via path 1219. If/when device 400B determines that HDR MIC 512 is valid, processing proceeds to operation 1224 via path 1223. At operation 1224 (e.g., responsive to the MPDU having a valid HDR MIC 512), device 400B may validate the MIC field of the data payload of the MPDU by calculating a MIC based on the data payload of the MPDU and by comparing the calculated MIC to the MIC for the data payload as included with the MPDU in the detected frame 500. Device 400B may determine that MIC for the data payload is valid when the calculated MIC matches the MIC for the data payload as included with the MPDU and may determine that the MIC for the data payload is invalid when the calculated MIC does not match the MIC for the data payload as included with the MPDU. If desired, operation 1222 may be performed concurrently with operation 1224 (e.g., in a single combined integrity check step with operation 1224) or prior to operation 1224.

If/when device 400B determines that the MIC for the data payload is invalid, processing may proceed to operation 1206 via path 1226. If/when device 400B determines that the MIC for the data payload is valid, and device 400B may recover or decrypt the data payload and processing proceeds to operation 1230 via path 1228. At operation 1230 (e.g., responsive to the MPDU having both a valid HDR MIC 512 and a valid data payload MIC), device 400B may prepare (generate) a BA frame 502 having a block ACK 518 (FIG. 5) that includes and/or otherwise identifies the corresponding MPDU received in frame 500 (e.g., the MPDU as checked at operations 1202-1224). Device 400B may transmit BA frame 502 to device 400A. Operations 1232 and 1234 of FIG. 12 are the same as operations 1030 and 1032 of FIG. 10, respectively. Description of operations 1232 and 1234 have therefore been omitted for the sake of brevity.

Device 400A generally has no knowledge when device 400B discards a frame or MPDU after transmission of BA frame 502 (e.g., as shown by path 1128 of FIG. 11 or path 1026 of FIG. 10). This may cause the receiver to miss such a frame. If desired, portions of the MAC header (e.g., a power management (PM) field, an end of service period (EOSP) field, a high throughput (HT) control field, and/or mobility domain (MD) bits) may be integrity protected and integrity checked during one or more of the checks of FIGS. 10-12 and/or in separate operations.

The examples of FIGS. 10-12 are illustrative and non-limiting. In general, device 400B may implement other integrity check procedures. Under any of these schemes, when the FCS, header PN, TSF, MAC header, and data payload have been validated for a given MPDU, device 400B may pass the MAC header and the data payload of the MPDU to its reorder buffer and may transmit BA frame 502 to device 400A with or without integrity protection and/or device 400A integrity checking the BA frame. When the FCS, header PN, TSF, and MAC header are valid but the payload MIC is invalid, neither the payload nor the MAC header are passed to the reorder buffer but device 400B may still transmit BA frame 502 to device 400A with or without integrity protection and/or device 400A integrity checking the BA frame. Alternatively, in these situations, device 400B may pass the MAC header to the reorder buffer when the HDR MIC of the MAC header is valid (e.g., when the header MIC is validated before validating the payload MIC). When FCS, header PN, and TSF are valid but the MAC header is invalid, neither the payload nor the MAC header are passed to the reorder buffer whether or not the data payload MIC is valid. Device 400B may still transmit BA frame 502 to device 400A without an integrity check but not with an integrity check. When the FCS, header PN, or TSF are invalid, neither the payload nor the MAC header are passed to the reorder buffer regardless of the MAC header integrity or the data payload integrity and device 400B does not transmit a BA frame 502 to device 400A.

Consider an example in which device 400B transmits an integrity-protected BA frame 502 to device 400A in response to a frame 500 having at least a first MPDU with SN=1, a second MPDU with SN=2, and a power management field of zero (e.g., PowerManagement=0). Frame 500 may solicit a corresponding BA frame 502 (e.g., the BA frame 502 transmitted by device 400B is a solicited BA frame). In some instances, BA frame 502 may be intercepted by device 402 (FIG. 4) (e.g., a MITM attacker) rather than being received at device 400A. In these situations, after a predetermined time period has elapsed without receipt of a BA frame corresponding to frame 500 at device 400A, device 400A may re-transmit frame 500 but with a power management field of one (e.g., PowerManagement=1). Device 402 may then intercept the re-transmitted frame. In response to intercepting the re-transmitted frame, device 402 may transmit (replay), to device 400A, the BA frame 502 received from device 400B. The replayed BA frame represents an insecure MITM transmission and interference in communications between devices 400A and 400B. Device 400A may integrity check the received BA frame 502 and may pass the received BA frame out of its temporary buffer when device 400A confirms that the received BA frame 502 is valid (e.g., while processing operation 610 of FIG. 6).

In these situations, device 400A may utilize a number of mechanisms to avoid being tricked into believing that a BA frame re-played by device 402 was actually transmitted by device 400B. First, device 400A may check that the addresses and FCS of the received BA frame match the BA frame as solicited by frame 500. Second, device 400A may check the PN of the received BA frame to ensure that the received BA frame is not a re-played BA frame from a MITM device. Third, BA frame 502 may include information identifying the TSF of the corresponding soliciting MPDU transmitted by device 400A. Device 400A may perform a TSF check on the received BA frame. This may involve validating the received BA frame only if it was transmitted within a predetermined time period (e.g., 256 us) of the TSF of the corresponding soliciting frame 500. If the TSF of the received BA frame is outside (after) the predetermined time period, device 400A may discard the received BA frame. As another example, device 400A may validate the received BA frame only if the hash/TSF of the soliciting frame matches the received BA frame (e.g., with an additional TSF/ID of the soliciting frame to avoid the BA frame transmission as a response to fake frames). Fourth, device 400A may validate the MIC 520 (FIG. 5) of the received BA frame (e.g., given that the content of the BA cannot be modified by device 402). If the received BA frame has an invalid MIC 520, device 400A may discard the BA frame. Device 400A may perform one or more of these integrity checks on a received BA frame 502 (e.g., at operation 610 of FIG. 6) before or after beginning to transmit its next frame 500.

The data frame integrity checking operations performed by device 400B (e.g., FIGS. 10-11) may be specified by the communication protocol governing wireless communication link 404 (FIG. 4). The BA frame integrity checking operations performed by device 400A may also be specified by the communication protocol (e.g., an IEEE 802.11 protocol). Device 400A may integrity check a received BA frame before or after TXOP continuation (e.g., a subsequent PPDU transmission). The communication protocol may also define an integrity check mode for BA frame 502. This may include a STA signaling, for uplink (UL) transmissions, and an AP signaling, for downlink (DL) transmissions: (1) a minimum MPDU start time (e.g., minimum MPDU start spacing 802 of FIG. 8), (2) a minimum EOF padding value (e.g., minimum EOF padding duration 804 of FIG. 8), (3) a minimum BA duration (e.g., minimum duration 902 of FIG. 9A), and/or a (4) minimum BA padding (e.g., for padding 900 of FIGS. 9A and 9B). Information identifying one or more of these values may be conveyed (signaled) between devices 400A and 400B (e.g., in MAC header 510 or another field of frame 500 and/or in a header, preamble, or other field of BA frame 502). This signaling may be at the link level, the multi-link device (MLD) level, or the multi-layer multi-domain (MLMD) level.

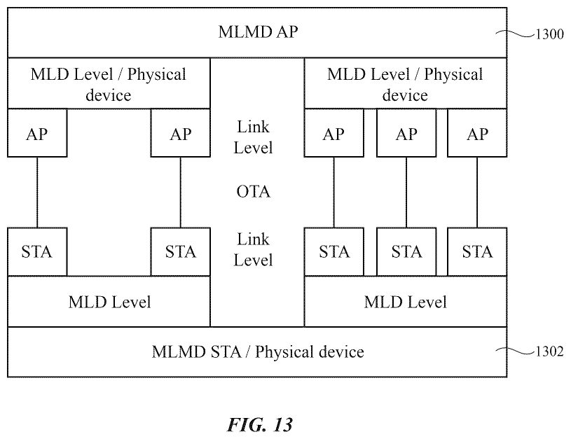

FIG. 13 is a diagram showing an exemplary signaling scheme between an AP and a STA when the AP is part of an MLMD AP 1300 and when the STA is part of an MLMD STA (physical device) 1302. As shown in FIG. 13, APs (e.g., AP 102 or 104 of FIG. 1) may exchange signals with corresponding STAs (e.g., STA 106A or 106B of FIG. 1) at the link level and over the air (OTA). Multiple APs may be logically grouped together to form a corresponding MLD level (physical) device. MLMD AP 1300 is a virtual device and may include multiple MLD level devices. The APs of a given MLD level device communicate with a corresponding set of STAs that are logically grouped together at the MLD level. MLMD STA 1302 may include multiple sets of STAs grouped together at the MLD level. A given AP may form one of device 400A or device 400B of FIG. 4, which communicates with a STA that forms the other of device 400A or 400B.

An MLMD STA may be implemented with different radios that are capable of operating at different frequencies. For instance, one radio may operate in a 2.4 GHz band, a second radio may operate in a 5 GHz band, and a third radio may operate in a 6 GHz band. These radios may have different capabilities for the four parameters to configure additional time needed to calculate or verify the integrity of data frames or BA frames. The MLMD level configurations may configure band-specific values for the four signaled values. In this configuration, the band-specific four signaled values are inherited for each link in the specific band.

As one example, each AP or STA (UL or DL) may configure different ones of the four signaled values (minimum MPDU start time, minimum EOF padding value, minimum BA duration, and minimum BA padding). These values may be signaled in association by using a multi-link (ML) element or an ML link reconfiguration add or modify frame. As another example, an AP and a set of STAs grouped together at the MLD level (UL and DL) may configure the four signaled values. In this example, the values may be kept the same at the MLD AP level. These values may be signaled in (re) association by using an ML element, or in ML link reconfiguration add or modify frames. As a further example, an AP and MLMD STA 1302 may configure the four signaled values. In this example, the values are kept the same within MLMD AP 1300. The values may be signaled in (re) association using an ML element. A STA or AP may optionally perform header and data payload MIC integrity checks prior to BA frame transmission, even if not required (e.g., the protocol-defined integrity check mode may be a minimum requirement).

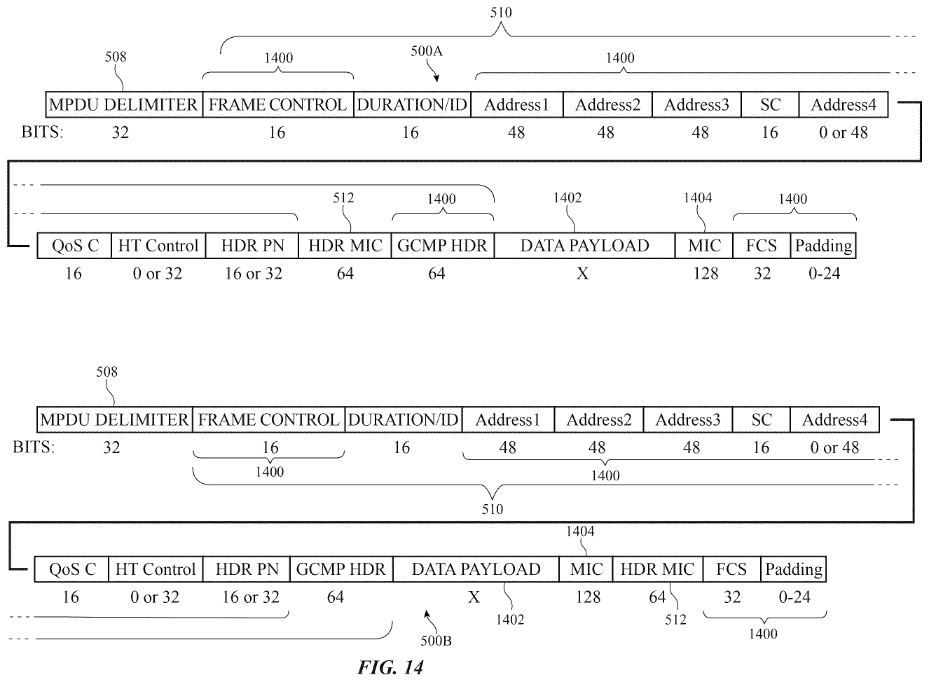

The example of FIG. 5 in which HDR MIC 512 is located between MAC header 510 and the data payload of frame 500 (e.g., MPDU field 514) is illustrative and non-limiting. FIGS. 14 shows two examples of other possible locations for the HDR MIC 512 in frame 500 (FIG. 5). Frame 500A of FIG. 14 shows an example in which HDR MIC 512 is placed between different fields of MAC header 510 (e.g., between a header (HDR) PN field and a Galois counter mode protection (GCMP) HDR field). Frame 500B of FIG. 14 shows another example in which HDR MIC 512 is placed after the data payload 1402 in frame 500 (e.g., after the payload MIC for data payload 1402). HDR MIC 512 may be an eight octet field having 64 total bits, for example.

Frame 500 (e.g., frame 500A and frame 500B) may include a data payload MIC 1404 appended to the end of its data payload 1402 (e.g., where the payload and payload MIC form part of the MPDU field 514 shown in FIG. 5). Payload MIC 1404 may be calculated based on data payload 1402. On the other hand, HDR MIC 512 is calculated based on the fields of MAC header 510 (e.g., the fields of MAC header 510 not including HDR MIC 512). Portions 1400 of frames 500A and 500B may be portions that are integrity protected by HDR MIC 512. Data payload 1402 is integrity protected by payload MIC 1404. The remaining portions of frames 500A and 500B may not have integrity protection.

Device 400A may separately and independently generate/calculate the HDR MIC and the payload MIC while generating frame 500. Device 400B may separately verify the HDR MIC and the payload MIC. Device 400B may integrity check both header MIC 512 (e.g., at operation 1024 of FIG. 10, operation 1122 of FIG. 11, or operation 1222 of FIG. 12) and payload MIC 1404 (e.g., at operation 1024 of FIG. 10, operation 1126 of FIG. 11, or operation 1224 of FIG. 12).

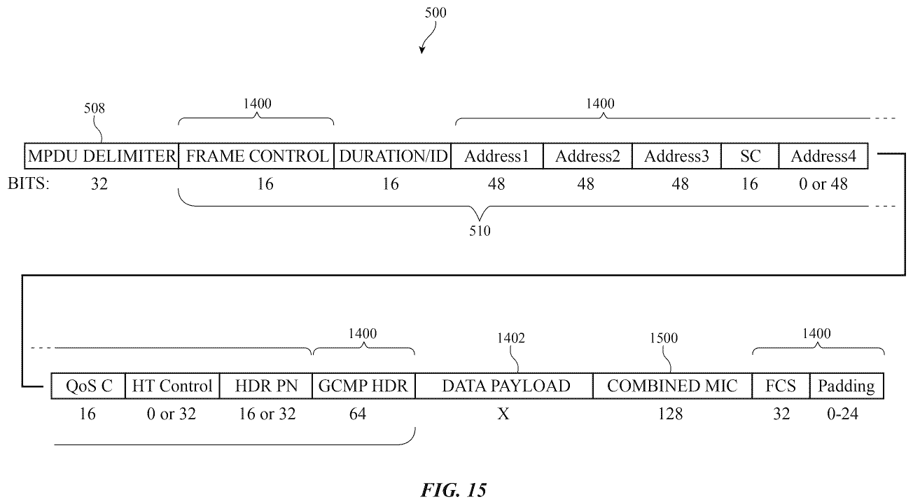

If desired, both the payload MIC 1404 (e.g., integrity protection for data payload 1402) and the HDR MIC 512 may be combined into a single combined MIC field. FIG. 15 shows one example of how frame 500 may include a single MIC that combines the integrity protection of HDR MIC 512 with the integrity protection of payload MIC 1404. As shown in FIG. 15, frame 500 includes a combined MIC field such as combined MIC 1500. Device 400A may generate combined MIC 1500 based on MAC header 510 and data payload 1402. Device 400A may, for example, generate HDR MIC 512 (FIG. 14) based on MAC header 510 (e.g., by inputting MAC header 510 to a hashing function), may generate payload MIC 1404 (FIG. 14) based on data payload 1402 (e.g., by inputting data payload 1402 to a hashing function), and by combining HDR MIC 512 with payload MIC 1404 (e.g., using an exclusive OR (XOR) function that outputs the value of HDR MIC 512 as XORed with payload MIC 1404). Combined MIC 1500 may therefore sometimes also be referred to herein as XOR MIC 1500 or the XOR 1500 of payload MIC 1404 and HDR MIC 512. In this implementation, device 400B may verify the integrity of both data payload 1402 and MAC header 510 at the same time (e.g., after BA frame transmission as shown in FIG. 10 or before BA frame transmission as shown in FIG. 12). Re-transmissions of frame may produce a different XOR value in XOR MIC 1500 because the MAC header is updated upon re-transmission.

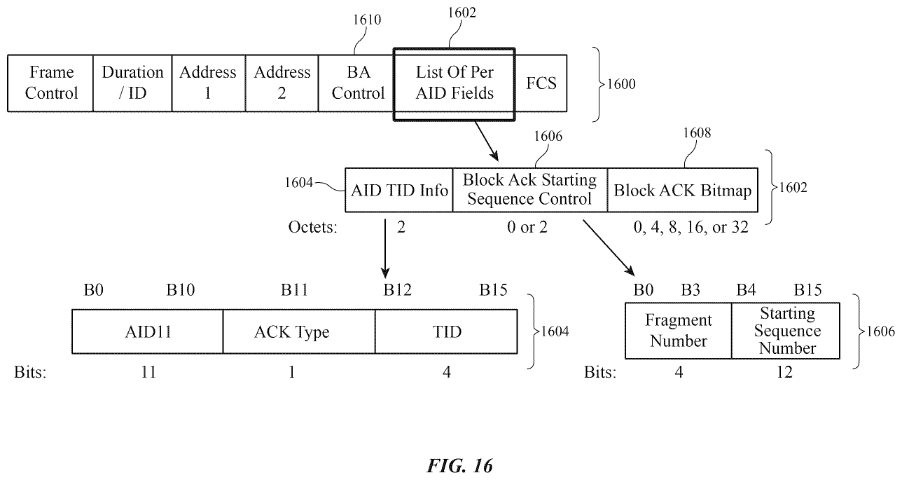

In some implementations, an AP may transmit a multi-STA BA frame that carries a BA bitmap to a single STA 106 (pairwise protection) or to multiple STAs 106 (broadcast protection) (e.g., while processing operation 608 of FIG. 6). The multi-STA BA frame may include one or more AID fields. The AID fields may be used to identify the STA which BA bitmap is signaled on the BA frame. FIG. 16 shows an example of an illustrative multi-STA BA frame 1600.

As shown in FIG. 16, multi-STA BA frame 1600 may include a frame control field, a duration/ID field, address fields, a BA control field 1610, a list of per AID fields 1602, and an FCS field. The list of per AID fields 1602 may, for example, form block ACK 518 of FIG. 5 and may include an AID TID information field, a block ACK starting sequence control field 1606, and a block ACK bitmap 1608. AID TID info field 1604 may include an AID11 field associated with block ACK bitmap 1608, an ACK type field associated with block ACK bitmap 1608, and a TID field associated with block ACK bitmap 1608. Block ACK starting sequence control field 1606 may include a fragment number field and a starting SN field.

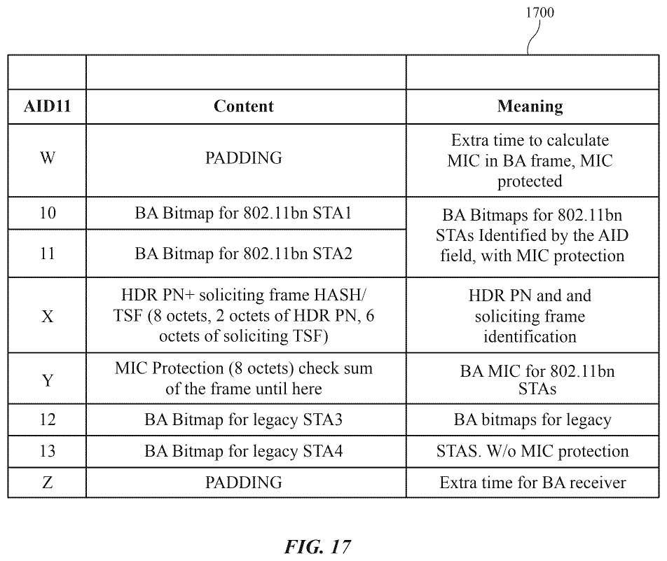

The fragment number field may specify the size of the bit map (e.g., 64 bits, 32 bits, etc.). The AID11 fields may be used to identify different information such as the HDR PN, soliciting frame TSF, and HDR MIC 512 of the frame 500 that solicited multi-STA BA frame 1600. FIG. 17 shows a table 1700 outlining different exemplary AID11 fields that may be included in AID TID info field 1604 of multi-STA BA frame 1600. The first column of table 1700 lists different AID11 fields, the second column lists the content of the corresponding AID11 field, and the third column lists the meaning of the corresponding AID11 field and its contents. If desired, BA control field 1610 (sometimes also referred to as BAR control field 1610, e.g., a two-bit field) may be followed by a variable-length BAR information field. If desired, the variable-length BAR information field may be followed by a control MIC field (e.g., similar to the header MICs described herein, which may be included within list 1602, which may be represented or identified by list 1602, or which may replace list 1601), followed by a variable length padding field, followed by a four-bit FCS field. Frame 1600 need not be a multi-STA BA frame in this implementation (e.g., frame 1600 may be any desired BAR frame in a BlockAckReq format). BA control field 1610 (sometimes also referred to herein as BAR control field 1610) may include, for example, a one-bit reserved field, followed by a four-bit BAR type field, followed by a one-bit protected control field, followed by a 1 bit Key ID field, followed by a five-bit reserved field, followed by a four-bit TID_INFO field. As another example, BA control field 1610 may include a two-bit reserved field after the Key ID field, followed by a one-bit no memory kept field, followed by a one-bit memory configuration tag field, followed by a one-bit management Ack field, followed by a four-bit TID_INFO field.

In the example of FIG. 17, a first AID11 field W is defined to include padding (e.g., padding 900 in FIGS. 9A and 9B). This may allow extra time for device 400B to calculate MIC 520 (FIG. 5). This field may be MIC protected (e.g., provided as an input to the hashing function when generating MIC 520). A second AID11 field (e.g., AID11 field “10”) may be defined to include the BA bitmap for a first STA 106 (STA1) operating under a first version of the communication protocol (e.g., an IEEE 802.11bn protocol). A third AID11 field (e.g., AID11 field “11”) may be defined to include the BA bitmap for a second STA 106 (STA2) operating under the first version of the communication protocol.

A fourth AID11 field X may be defined to include or identify the HDR PN of the corresponding soliciting frame 500 and/or to include or identify the hash (e.g., a hash identifier) and/or TSF of the corresponding soliciting frame 500 (e.g., including two octets for the HDR PN and six octets for the TSF of the soliciting frame). A fifth AID11 field Y may be defined to include or identify the MIC protection and/or check sum of the corresponding frame 500 up to this point (e.g., the BA MIC such as MIC 520 of FIG. 5 for STAs operating under the first version of the communication protocol).

A sixth AID11 field (e.g., AID11 field “12”) may be defined to include a BA bitmap for a third STA 106 (STA3) operating under a second version of the communication protocol (e.g., a legacy version of the communication protocol) that is older than the first version of the communication protocol. A seventh AID11 field (e.g., AID11 field “13”) may be defined to include a BA bitmap for a fourth STA 106 (STA4) operating under a second version of the communication protocol. These fields may include BA bitmaps for legacy STAs without MIC protection. An eighth AID11 field Z may be defined to include padding (e.g., padding 900 in FIGS. 9A and 9B). The example of FIG. 17 is illustrative and non-limiting and, in general, any desired AID11 fields may be specified for any desired purposes.

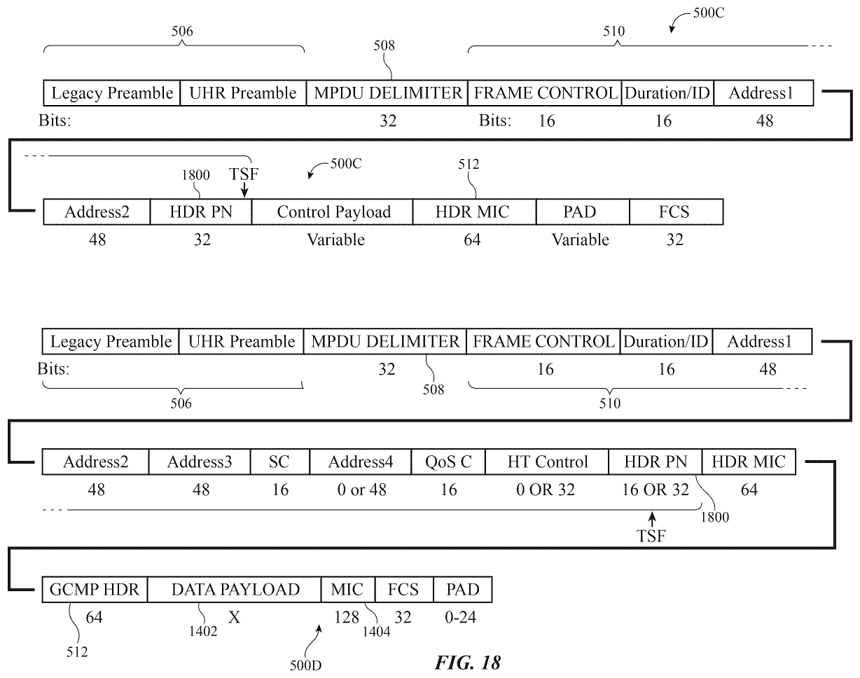

FIG. 18 shows two additional examples of frames 500 that may be transmitted by device 400A as a soliciting frame for a BA frame 502 transmitted by device 400B. Frame 500C is one example in which frame 500 is a block acknowledgment request (BAR) frame 500C. As shown by BAR frame 500C, information identifying the TSF of frame 500C may be inserted into HDR PN field 1800 within MAC header 510 (e.g., prior to the payload, which may include a variable length control payload). The same TSF may be present in all HDR PN values. Frame 500D is another example in which frame 500 is a data or management frame. As shown by data or management frame 500D, information identifying the TSF of frame 500D may be inserted into HDR PN field 1800 within MAC header 510. This may be followed by HDR MIC field 512, data payload 1402, payload MIC 1404, etc.

The information identifying the TSF of frame 500C may be inserted into HDR PN field 1700 in any desired manner. As one example, HDR PN field 1800 may include a first numerical value (e.g., one or more HDR_Number bits) followed by a second numerical value (e.g., one or more bits) that identifies the TSF. The first numerical value may be identified using a first octet and a portion of a second octet (e.g., the most significant bit(s) of the second octet), for example. The second numerical value, identifying the TSF, may be stored in a remainder (e.g., the least significant bit(s)) of the second octet. The first numerical value may, for example, be increased by one for each integrity protection (e.g., up to a PN for 2¹⁰=1,024 MPDUs, corresponding to a maximum BA window size). The TSF may be set to the TSF of the corresponding PPDU transmission time. The TSF may range from a smallest TSF (time) value such as 2⁴ us=16 us to a largest TSFT (time) value such as ˜210=1,008 us. The receiver may drop received frames with a TSF difference larger than +/−256 us to its internal TSF value, for example. In a Nonce implementation, the HDR PN field 1800 may be padded with four octets of TSF to make the Nonce 6 octets if desired. As another example, HDR PN field 1800 may include a general number. In Nonce, HDR PN field 1800 is padded with two octets or all ones to make the Nonce six octets in length. This alternative may allow for the replay of frames and does not require TSF synchronization.

Additionally or alternatively, frame 500 may identify that it is a soliciting frame by calculating a hash on the soliciting frame. In these implementations, device 400A may identify that frame 500 is a soliciting frame using frame control, duration, retry, preamble, and addresses (e.g., constant values not depending on receive operation). This generally does not require a TSF-based nonce but may require collection of a large amount of data. Alternatively, device 400A may identify that frame 500 is a soliciting frame using frame control, duration, retry, preamble, addresses, and smallest received sequence number (SN) and HDR PN value techniques. This information is based on BA frame content and may add processing time and complexity.

Consider an example in which an AP and STA have set up a target wakeup time (TWT) service period (SP) and in which an attacker (e.g., device 402 of FIG. 4) receives the AP transmissions but causes interference to the STA that prevents the STA from receiving frames. In the next TWT SP, the attacker might reply with a frame that will early terminate the TWT SP. The STA may be confused and not receive any frames in the TWT SP. The attacker may block Buffer Status information transmission and may retransmit the old Buffer Status information at a later time. This may cause incorrect allocations for the STA. This attack scenario leads to two new protections for the transmitted frames.

First, MIC protection of the MPDU header, MPDU data payload, and BA frames may be used to avoid modifications and fake frames. MIC protection generally offers poor protection against replays of non-received frames. MIC protection may also add delays if performed prior to transmission of the BA frame. Second, TSF may be utilized to avoid replays of old data and BA frames. Replay protection may be irrelevant for MAC header information because the header information may change over time. However, TSF-based protection may protect against replays of MPDUs by the attacker. BA frames may include replay protection that ensures that the BA frame 502 is transmitted as a response to a corresponding soliciting frame 500. BA frame replay protection is especially relevant when the data receiver performs integrity checks after transmission of the BA frame.

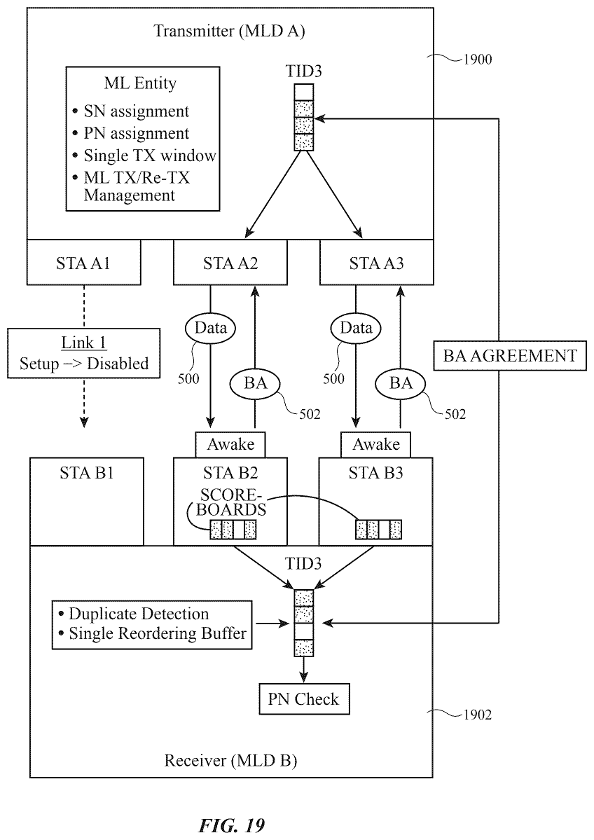

FIG. 19 shows an example in which an MLD transmitter 1900 transmits frames 500 to an MLD receiver 1902 and in which MLD receiver 1902 transmits BA frames 502 to MLD transmitter 1900. MLD transmitter 1900 may include a set of STAs including STA A1, STA A2, and STA A3 (e.g., AP STAs or non-AP STAs). MLD receiver 1902 may include a set of STAs include STA B1, STA B2, and STA B3 (e.g., non-AP STAs or AP STAs).

As shown in FIG. 19, MLD transmitter 1900 controls the MPDU sequence numbers that are transmitted to MLD receiver 1902 (e.g., MLD transmitter 1900 may control SN assignment, PN assignment, single TX window assignment, and ML TX/Rc-TX management). Transmitter 1900 has a transmit buffer 1904 that stores all frames in transmission (see, e.g., transmit buffer 406 of FIG. 4). Frames that are currently in transmission are stored in STA-specific buffers (sec, e.g., temporary buffer 408 of FIG. 4). MLD receiver 1902 receives frames 500, temporarily stores information from the frames in scoreboards for different STAs, and then provides information from the scoreboards to a single reordering buffer that performs duplicate detection, PN checking, etc.

MLD receiver 1902 may acknowledge all received frames 500 but has no control over the MPDUs in transmission. If a stateless BA is assumed, BA bitmaps may signal, for each MPDU that is acknowledged in a BA frame: that an MPDU is received (e.g., using a value “1”) or that an MPDU is not received or that the receiver otherwise has no knowledge of the MPDU (e.g., using a value “0”). When the BA frame is integrity protected, MLD transmitter 1900 needs to integrity check the BA frame before updating its transmission buffer. This may eliminate attacks using fake BA frames.

Consider another example in which device 400B checks both the HDR MIC and the payload MIC of a received frame 500 after transmitting BA frame 502. If care is not taken, this can produce a BA off-synchronization problem. In this example, device 400B may end up discarding a received frame after transmitting the corresponding BA frame 502. This can produce a hole in the reorder buffer on device 400B. This data is not forwarded to its corresponding application until the hole is filled or the BA window moves forward. However, the BA frame signals to device 400A that the transmission of frame 500 was acceptable to device 400B. Device 400A can then erase the frame from its transmission buffer and does not know that device 400B is waiting for retransmission of the frame.

In a first example, this BA off-synchronization problem may be solved using a silent reorder buffer update at device 400B. In this example, device 400B may detect that a payload MIC or a header MIC of the received frame 500 fails for MPDUs in the received frame after transmitting the corresponding BA frame. However, device 400B may include internal logic that checks when to forward the MPDUs to its reorder buffer. Device 400B may, for example, check whether device 400A will have enough time to retransmit the MPDUs. Device 400B may, for example, check whether device 400A has progressed on transmitted SN values and has sent larger SNs than already received. If this internal condition is met, device 400B may silently forward the MPDUs to its reorder buffer. This will cause loss of MPDUs having invalid integrity after transmission of the BA frame.

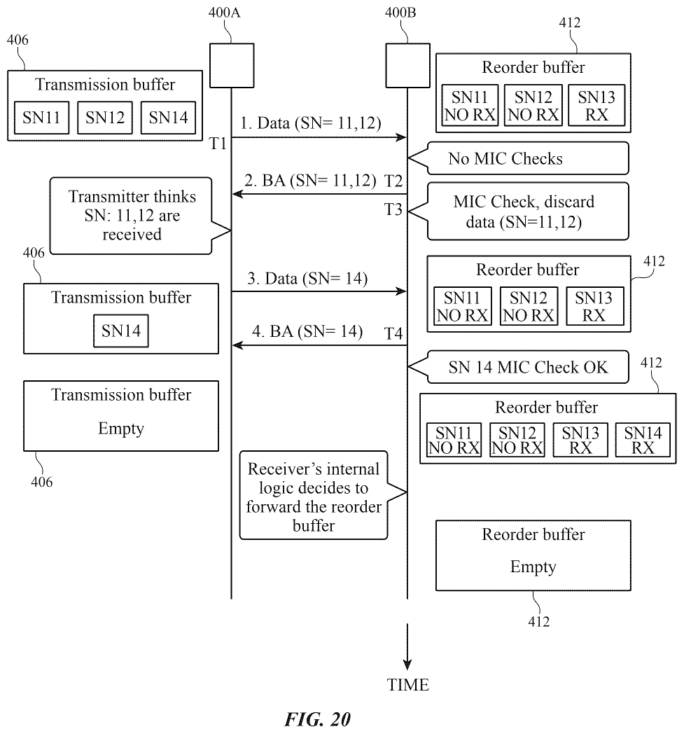

An example of this type of solution is shown in the timing diagram of FIG. 20. In the example of FIG. 20, device 400A transmits MPDUs of SN=11 and 12 at time T1. Device 400B may store a previously received and integrity checked MPDU of SN=13 in its reorder buffer but has not yet integrity checked the received MPDUs of SN=11 and 12, so the received MPDUs of SN=11 and 12 have not yet been passed to the reorder buffer. Device 400B transmits a BA frame 502 acknowledging the MPDUs of SN=11 and 12 at time T2, despite having not yet integrity checked the MPDUs of SN=11 and 12.

At time T3, device 400B has finished calculating that the received MPDUs of SN=11 and 12 have failed the integrity check. Device 400B may then discard the invalid MPDUs of SN=11 and 12. However, since device 400B has already transmitted the BA frame for MPDUs of SN=11 and 12, device 400A incorrectly believes that device 400B has received the MPDUs of SN=11 and 12, causing device 400A to delete the MPDUs of SN=11 and 12 from its transmission buffer.

Device 400A may then transmit the next MPDU having SN=14 to device 400B. Device 400B receives the MPDU of SN=14, transmits a corresponding BA frame for the MPDU of SN=14 to device 400A, and then determines at time T4 that the MPDU of SN=14 has passed the integrity check. Upon passing the integrity check, device 400B places the MPDU of SN=14 into the reorder buffer (e.g., in the correct sequential order after the MPDU of SN=13). The internal logic on device 400B may silently forward the MPDU of SN=14 to the reorder buffer while ignoring the discarded MPDUs of SN=11 and 12, causing loss of those MPDUs but re-synchronizing device 400B to device 400A (e.g., solving the BA off-synchronization problem).

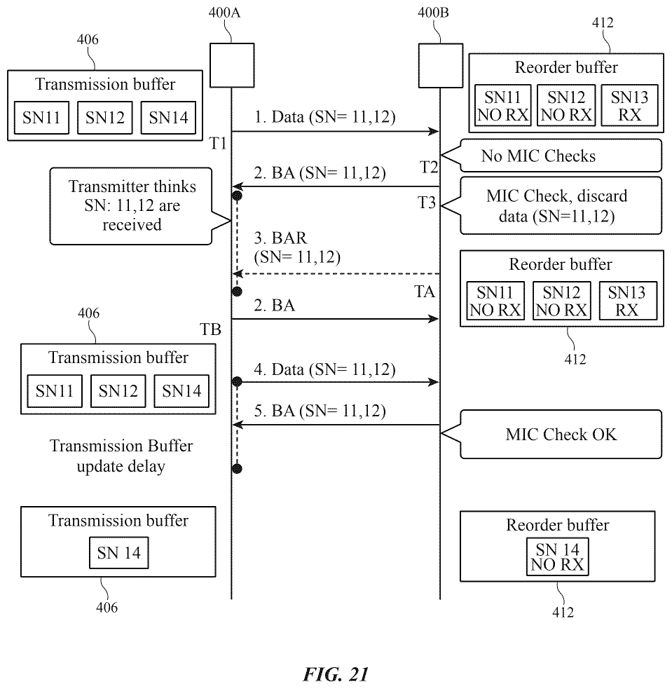

In another example, shown in the timing diagram of FIG. 21, the BA off-synchronization problem may be solved using a delay to the transmit buffer. As shown in FIG. 21, rather than waiting for device 400A to transmit the next MPDU in the sequence after the MPDUs of SN=11 and 12 fail the MIC check at time T3, device 400B may instead transmit an integrity-protected BAR frame to device 400A that identifies the dropped MPDUs of SN=11 and 12. This signaling of the dropped MPDUs or frames is also referred to as reorder buffer status signaling. The BAR frame may signal or identify holes in the reorder buffer on device 400B (e.g., as caused by MIC check failures or holes that cause delays to low delay frames forwarding to the corresponding application).

At time TB, device 400A may transmit a BA frame in response to the BAR frame received from device 400B. The transmitter may apply a transmission buffer update delay (e.g., “TransmissionBufferUpdateDelay”). This delay may allow sufficient time for device 400A to re-transmit the MPDUs of SN=11 and 12. Device 400B may transmit a BA frame in response to the re-transmission of the MPDUs of SN=11 and 12 and may then determine that the re-transmitted MPDUs have valid integrity. Device 400A may then transmit its next MPDU of SN=14 to device 400B.

As another example, if desired, device 400B may transmit a multi-STA frame 1600 (FIG. 16) to signal to device 400A that its reorder buffer is missing MPDUs transmitted by device 400A (e.g., at time TA of FIG. 21). In this example, the BA control field 1610 of multi-STA BA frame 1600 (FIG. 16) may include information identifying the status of the reorder buffer 412 on device 400B.

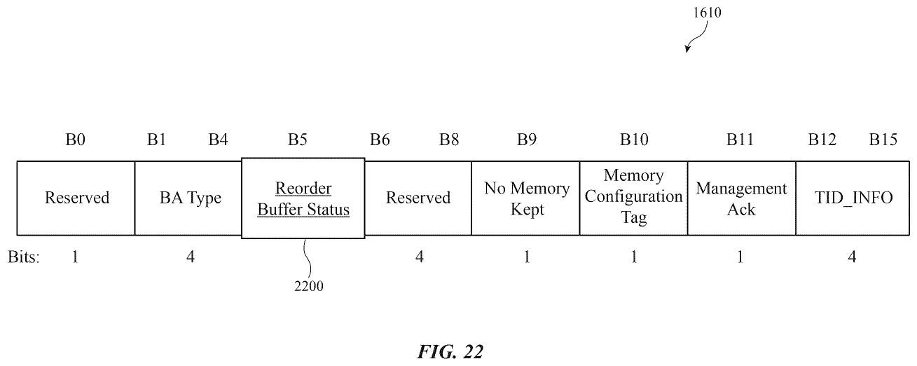

FIG. 22 shows on example of information that may be stored in the BA control field 1610 of multi-STA BA frame 1600 to signal the reorder buffer status of device 400B to device 400A. As shown in FIG. 22, BA control field 1610 may include information about the status of its reorder buffer 412 such as reorder buffer status field 2200. Reorder buffer status field 2200 may include one or more bits. Reorder buffer status field 2200 may be a first value (e.g., a bit set to “1”) to identify, to device 400A, that multi-STA BA frame 1600 includes one or more ReorderBufferStatus per AID Fields. Reorder buffer status 2200 may be a second value (e.g., a bit set to “0”) to identify, to device 400A, that multi-STA BA frame 1600 does not include any ReorderBufferStatus per AID Field. If desired, a new AID field (e.g., an AID11 field) may be defined that signals the ReorderBufferStatus start.

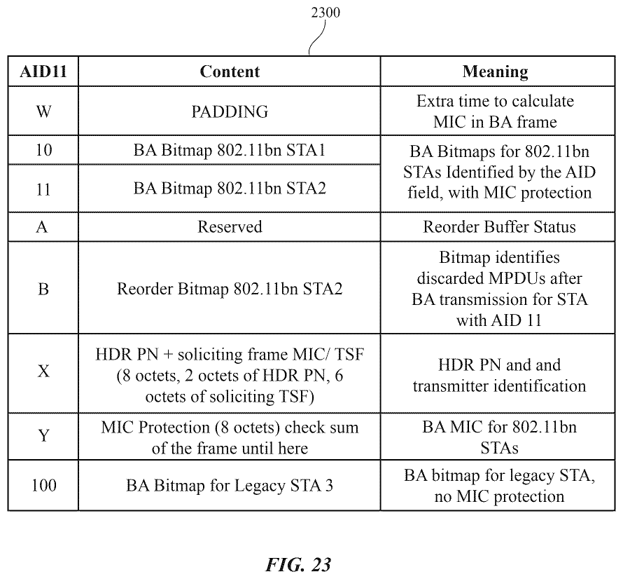

FIG. 23 shows a table 2300 outlining additional exemplary AID11 fields that may be included in AID TID info field 1604 of multi-STA BA frame 1600 (e.g., a multi-STA BA frame 1600 having reorder buffer status 2200 in its BA control field 1610 as shown in FIG. 22). In the example of FIG. 23, an AID11 field A is reserved to identify the status of the reorder buffer 412 on device 400B. An AID11 field B may be defined to include a reorder bitmap for the corresponding STA (e.g., STA2) operating under the first version of the communications protocol (e.g., IEEE 802.11bn). This bitmap identifies MPDUs that were discarded by device 400A after transmission of BA frame 502 (e.g., the MPDUs of SN=11 and 12 in the example of FIG. 21). If desired, an AID11 field (e.g., AID11 field “100”) may be defined to include a BA bitmap for a legacy STA (e.g., STA3) without MIC protection. The example of FIG. 23 is illustrative and non-limiting and, in general, any desired AID11 fields may be specified for any desired purposes.

In this example, the transmitter (e.g., device 400A) controls retransmissions and selects a suitable operation after receiving the reorder buffer status from device 400B (e.g., in multi-STA BA frame 1600). In a best case, the transmitter may then retransmit a failed MPDU. In a default cause, the transmitter may move the reorder buffer forward. This may re-synchronize the transmitter and receiver block ACKs, may allow blocked data in the reorder buffer to be moved to the corresponding application at the receiver (e.g., device 400B), and the hole/missed frame may be retransmitted in a TCP retransmission or another higher layer retransmission mechanism. As BA windows get larger (e.g., supporting up to 1024 MPDUs), a hole may block frames for increasingly long times, causing higher transmission delays.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

STAs 106 and APs 102/104 (FIG. 1) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-23 may be performed by the components of a STA and/or AP using software, firmware, and/or hardware (e.g., dedicated circuitry or hardware). Software code for performing these operations may be stored on non-transitory computer readable storage media (e.g., tangible computer readable storage media) stored on one or more of the components of the STA and/or AP. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the STA and/or AP. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a first electronic device to wirelessly communicate with a second electronic device, the method comprising: transmitting, using one or more antennas, an integrity-protected frame for receipt by the second electronic device, wherein the integrity-protected frame includes a preamble, a media access control (MAC) header, a delimiter between the preamble and the MAC header, a message integrity check (MIC) field based on the MAC header, a data payload, the MAC header being between the data payload and the delimiter, and a padding field configured to accommodate a processing delay associated with generating or verifying the MIC field.

Example 2 includes the method of example 1 or some other example or combination of examples herein, wherein the padding field is between the delimiter and the MAC header in the integrity-protected frame.

Example 3 includes the method of any one of examples 1 or 2 or some other example or combination of examples herein, wherein the padding field comprises a duplicate of the delimiter.

Example 4 includes the method of any one of examples 1-3 or some other example or combination of examples herein, wherein the delimiter comprises an aggregated MAC protocol data unit (A-MPDU) associated with the data payload.

Example 5 includes the method of any one of examples 1-4 or some other example or combination of examples herein, wherein the padding field is between the MAC header and the MIC field in the integrity-protected frame.

Example 6 includes the method of any one of examples 1-5 or some other example or combination of examples herein, wherein the padding field is between the MIC field and the data payload of the integrity-protected frame.

Example 7 includes the method of any one of examples 1-6 or some other example or combination of examples herein, wherein the padding field is appended to an end of the data payload.

Example 8 includes the method of any one of examples 1-7 or some other example or combination of examples herein, wherein the integrity-protected frame further comprises: a first MAC protocol data unit (MPDU) field that includes the data payload; a second MPDU field that includes an additional data payload; a first set of padding fields that includes the padding field, the padding fields in the first set comprising duplicates of the delimiter; and a second set of padding fields appended to an end of the second MPDU, the padding fields in the second set comprising end of frame (EOF) bits.

Example 9 includes the method of any one of examples 1-8 or some other example or combination of examples herein, further comprising: receiving, using the one or more antennas, an integrity-protected block acknowledgment (BA) frame from the second electronic device; and verifying, using one or more processors, an additional MIC field of the BA frame.

Example 10 includes the method of any one of examples 1-9 or some other example or combination of examples herein, wherein the MAC header comprises a packet number (PN) field and wherein the PN field identifies a first time synchronization function (TSF) of the integrity-protected frame.

Example 11 includes the method of any one of examples 1-10 or some other example or combination of examples herein, wherein the BA frame identifies a second TSF, the method further comprising: discarding the BA frame when the second TSF is after a predetermined time range from the first TSF.

Example 12 includes the method of any one of examples 1-11 or some other example or combination of examples herein, wherein the BA frame comprises a hash identifier associated with the integrity-protected frame.

Example 13 includes the method of any one of examples 1-12 or some other example or combination of examples herein, wherein the integrity-protected frame further comprises: an additional MIC field based on the data payload, the data payload being between the additional MIC field and the MAC header in the integrity-protected frame.

Example 14 includes the method of any one of examples 1-13 or some other example or combination of examples herein, wherein the MIC field is between the data payload and a packet number (PN) field of the MAC header in the integrity-protected frame.

Example 15 includes the method of any one of examples 1-14 or some other example or combination of examples herein, wherein the additional MIC field is between the MIC field and the data payload in the integrity-protected frame.

Example 16 includes the method of any one of examples 1-15 or some other example or combination of examples herein, further comprising: generating, using one or more processors, a first MIC value based on the MAC header; generating, using the one or more processors, a second MIC value based on the data payload; and generating, using the one or more processors, the MIC field by performing an exclusive OR (XOR) operation on the first MIC value and the second MIC value, the data payload being between the MIC field and the MAC header in the integrity-protected frame.

Example 17 includes a method of operating a first electronic device to wirelessly communicate with a second electronic device, the method comprising: receiving, using one or more antennas, a frame; and transmitting, using the one or more antennas, an integrity-protected block acknowledgement (BA) frame for receipt by the second electronic device, wherein the integrity-protected BA frame includes a preamble, a block acknowledgment (ACK) to a media access control protocol data unit (MPDU) in the frame, a message integrity check (MIC) field based on the block ACK, the block ACK being between the MIC field and the preamble in the integrity-protected BA frame, and a padding field configured to accommodate a processing delay associated with generating or verifying the MIC field.

Example 18 includes the method of example 17 or some other example or combination of examples herein, wherein the padding field is between the block ACK and the MIC field in the integrity-protected BA frame.

Example 19 includes the method of any one of examples 17, 18, or some other example or combination of examples herein, wherein the padding field is between the block ACK and the preamble in the integrity-protected BA frame.

Example 20 includes the method of any one of examples 17-19 or some other example or combination of examples herein, wherein the padding field comprises an association identifier (AID) traffic identifier (TID) Info field that is unassociated with any station (STA) in communication with the first and second electronic devices.

Example 21 includes the method of any one of examples 17-20 or some other example or combination of examples herein, wherein the integrity-protected BA frame comprises a block ACK bitmap and the padding field comprises an association identifier 11 (AID11) field associated with the block ACK bitmap.

Example 22 includes the method of any one of examples 17-21 or some other example or combination of examples herein, wherein the integrity-protected BA frame comprises a BA control field and the BA control field includes one or more bits identifying a status of a reorder buffer on the first electronic device.

Example 23 includes the method of any one of examples 17-22 or some other example or combination of examples herein, wherein the integrity-protected BA frame comprises an association identifier 11 (AID11) field that identifies one or more MPDUs that were discarded from a reorder buffer on the first electronic device.

Example 24 includes a method of operating a first electronic device to wirelessly communicate with a second electronic device, the method comprising: receiving, using one or more antennas, a frame; transmitting, using the one or more antennas, a block acknowledgement (BA) frame for receipt by the second electronic device, wherein the BA frame includes a block acknowledgment (ACK) to a media access control protocol data unit (MPDU) in the frame; and attempting to verify, using one or more processors prior to transmission of the integrity-protected BA frame, integrity of a media access control (MAC) header of the MPDU in the frame.

Example 25 includes the method of example 24 or some other example or combination of examples herein, further comprising: attempting to verify, using the one or more processors after transmission of the integrity-protected BA frame, integrity of a data payload of the MPDU in the frame.

Example 26 includes the method of any one of example 24, 25, or some other example or combination of examples herein, further comprising: attempting to verify, using the one or more processors prior to transmission of the integrity-protected BA frame, integrity of a data payload of the MPDU in the frame.

Example 27 includes a method of operating a first electronic device to wirelessly communicate with a second electronic device, the method comprising: receiving, using one or more antennas, a frame; transmitting, using the one or more antennas, a block acknowledgement (BA) frame for receipt by the second electronic device, wherein the BA frame includes a block acknowledgment (ACK) to a media access control protocol data unit (MPDU) in the frame; calculating, using one or more processors after of the integrity-protected BA frame, a message integrity check (MIC) value based on at least some of the MPDU; and transmitting, using the one or more antennas, a block acknowledgment request (BAR) frame when the calculated MIC value does not match a corresponding MIC field included in the frame, wherein the BAR frame identifies the MPDU.

Example 28 may include an apparatus comprising means to perform one or more elements of a method described in or related to any of examples 1-27 or any combination thereof, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-27 or any combination thereof, or any other method or process described herein.

Example 30 may include an apparatus comprising logic, modules, or circuitry to perform one or more elements of a method described in or related to any of examples 1-27 or any combination thereof, or any other method or process described herein.

Example 31 may include a method, technique, or process as described in or related to any of examples 1-27 or any combination thereof, or portions or parts thereof.

Example 32 may include an apparatus comprising: one or more processors and one or more non-transitory computer-readable storage media comprising instructions that, when executed by the one or more processors, cause the one or more processors to perform the method, techniques, or process as described in or related to any of examples 1-27, or any combination thereof, or portions thereof.

Example 33 may include a signal as described in or related to any of examples 1-27, or any combination thereof, or portions or parts thereof.

Example 34 may include a datagram, information element, packet, frame, segment, PDU, or message as described in or related to any of examples 1-27, or any combination thereof, or portions or parts thereof, or otherwise described in the present disclosure.

Example 35 may include a signal encoded with data as described in or related to any of examples 1-26, or any combination thereof, or portions or parts thereof, or otherwise described in the present disclosure.

Example 36 may include a signal encoded with a datagram, IE, packet, frame, segment, PDU, or message as described in or related to any of examples 1-26, or any combination thereof, or portions or parts thereof, or otherwise described in the present disclosure.

Example 37 may include an electromagnetic signal carrying computer-readable instructions, wherein execution of the computer-readable instructions by one or more processors is to cause the one or more processors to perform the method, techniques, or process as described in or related to any of examples 1-27, or any combination thereof, or portions thereof.

Example 38 may include a computer program comprising instructions, wherein execution of the program by a processing element is to cause the processing element to carry out the method, techniques, or process as described in or related to any of examples 1-27, or any combination thereof, or portions thereof.

Example 39 may include a signal in a wireless network as shown and described herein.

Example 40 may include a method of communicating in a wireless network as shown and described herein.

Example 41 may include a system for providing wireless communication as shown and described herein.

Example 42 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. A method of operating a first electronic device to wirelessly communicate with a second electronic device, the method comprising:
transmitting, using one or more antennas, an integrity-protected frame for receipt by the second electronic device, wherein the integrity-protected frame includes
a preamble,
a media access control (MAC) header,
a delimiter between the preamble and the MAC header,
a message integrity check (MIC) field based on the MAC header,
a data payload, the MAC header being between the data payload and the delimiter, and
a padding field configured to accommodate a processing delay associated with generating or verifying the MIC field.

2. The method of claim 1, wherein the padding field is between the delimiter and the MAC header in the integrity-protected frame.

3. The method of claim 2, wherein the padding field comprises a duplicate of the delimiter and wherein the delimiter comprises an aggregated MAC protocol data unit (A-MPDU) associated with the data payload.

4. The method of claim 1, wherein the padding field is between the MAC header and the MIC field in the integrity-protected frame.

5. The method of claim 1, wherein the padding field is between the MIC field and the data payload of the integrity-protected frame.

6. The method of claim 1, wherein the padding field is appended to an end of the data payload.

7. The method of claim 1, wherein the integrity-protected frame further comprises:
a first MAC protocol data unit (MPDU) field that includes the data payload;
a second MPDU field that includes an additional data payload;
a first set of padding fields that includes the padding field, the padding fields in the first set comprising duplicates of the delimiter; and
a second set of padding fields appended to an end of the second MPDU, the padding fields in the second set comprising end of frame (EOF) bits.

8. The method of claim 1, further comprising:
receiving, using the one or more antennas, a block acknowledgment (BA) frame from the second electronic device; and
verifying, using one or more processors, an additional MIC field of the BA frame.

9. The method of claim 8, wherein the MAC header comprises a packet number (PN) field and wherein the PN field identifies a first time synchronization function (TSF) of the integrity-protected frame and wherein the BA frame identifies a second TSF, the method further comprising:
discarding the BA frame when the second TSF is after a predetermined time range from the first TSF.

10. The method of claim 8, wherein the BA frame comprises a hash identifier associated with the integrity-protected frame.

11. The method of claim 1, wherein the integrity-protected frame further comprises:
an additional MIC field based on the data payload, the data payload being between the additional MIC field and the MAC header in the integrity-protected frame.

12. The method of claim 11, wherein the MIC field is between the data payload and a packet number (PN) field of the MAC header in the integrity-protected frame.

13. The method of claim 11, wherein the additional MIC field is between the MIC field and the data payload in the integrity-protected frame.

14. The method of claim 1, further comprising:
generating, using one or more processors, a first MIC value based on the MAC header;
generating, using the one or more processors, a second MIC value based on the data payload; and
generating, using the one or more processors, the MIC field by performing an exclusive OR (XOR) operation on the first MIC value and the second MIC value, the data payload being between the MIC field and the MAC header in the integrity-protected frame.

15. A method of operating a first electronic device to wirelessly communicate with a second electronic device, the method comprising:
receiving, using one or more antennas, a frame; and
transmitting, using the one or more antennas, an integrity-protected block acknowledgement (BA) frame for receipt by the second electronic device, wherein the integrity-protected BA frame includes
a preamble,
a block acknowledgment (ACK) to a media access control protocol data unit (MPDU) in the frame,
a message integrity check (MIC) field based on the block ACK, the block ACK being between the MIC field and the preamble in the integrity-protected BA frame, and
a padding field configured to accommodate a processing delay associated with generating or verifying the MIC field.

16. The method of claim 15, wherein the padding field is between an end of the MIC field and a beginning of a frequency checksum field of the integrity-protected BA frame.

17. The method of claim 15, wherein the padding field is between the block ACK and the MIC field in the integrity-protected BA frame.

18. A method of operating a first electronic device to wirelessly communicate with a second electronic device, the method comprising:
receiving, using one or more antennas, a frame;
transmitting, using the one or more antennas, a block acknowledgement (BA) frame for receipt by the second electronic device, wherein the BA frame includes a block acknowledgment (ACK) to a media access control protocol data unit (MPDU) in the frame; and
attempting to verify, using one or more processors prior to transmission of the integrity-protected BA frame, integrity of a media access control (MAC) header of the MPDU in the frame.

19. The method of claim 18, further comprising:
attempting to verify, using the one or more processors after transmission of the integrity-protected BA frame, integrity of a data payload of the MPDU in the frame.

20. The method of claim 18, further comprising:
attempting to verify, using the one or more processors prior to transmission of the integrity-protected BA frame, integrity of a data payload of the MPDU in the frame.
